(19) United States
(12) Patent Application Publication
(10) Pub. No.: US 2024/0223240 A1
(43) Pub. Date: Jul. 4, 2024

(54) SYSTEMS AND METHODS FOR USING A RADIO INTELLIGENT CONTROLLER WITH A DISTRIBUTED ANTENNA SYSTEM AND FRONTHAUL MULTIPLEXER/FRONTHAUL GATEWAY

(71) Applicant: CommScope Technologies LLC, Claremont, NC (US)

(72) Inventors: Harsha Hegde, Buffalo Grove, IL (US); Ehsan Daeipour, Southborough, MA (US); Shailendra Yadav, Gurgaon (IN)

(73) Assignee: CommScope Technologies LLC, Claremont, NC (US)

(21) Appl. No.: 18/402,432

(22) Filed: Jan. 2, 2024

Related U.S. Application Data
(60) Provisional application No. 63/478,177, filed on Jan. 2, 2023.

(51) Int. Cl. H04B 7/024; H04W 24/02

(52) U.S. Cl. CPC H04B 7/024; H04W 24/02

(57) ABSTRACT

Systems and methods for using a radio intelligent controller with a distributed antenna system and fronthaul multiplexer/fronthaul gateway (FHM/FHGW) are provided. In one example, a method for using a radio intelligent controller with a DAS includes receiving fronthaul information via an E2 interface from one or more nodes of the DAS included in a system. The method further includes automatically generating one or more operational parameters for one or more components of the system that includes the DAS based on the fronthaul information received via an E2 interface from the one or more nodes of the DAS. The method further includes adjusting operation of one or more components of the system that includes the DAS based on the one or more automatically generated operational parameters for the one or more components of the system that includes the DAS.

### CROSS-REFERENCE TO RELATED APPLICATIONS

This application claims priority to U.S. Provisional Application No. 63/478,177, filed on Jan. 2, 2023, and titled “SYSTEMS AND METHODS FOR USING A RADIO INTELLIGENT CONTROLLER WITH A DISTRIBUTED ANTENNA SYSTEM AND FRONTHAUL MULTIPLEXER/FRONTHAUL GATEWAY,” the contents of which are incorporated by reference herein in their entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote units”), where each access point can be coupled directly to one or more of the central access nodes or indirectly via one or more other remote units and/or via one or more intermediary or expansion units or nodes (also referred to here as “transport expansion nodes (TENs)”). A DAS is typically used to improve the coverage provided by one or more base stations that are coupled to the central access nodes. These base stations can be coupled to the one or more central access nodes via one or more cables or via a wireless connection, for example, using one or more donor antennas. The wireless service provided by the base stations can include commercial cellular service and/or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals that are radiated from one or more coverage antennas associated with that access point. The downlink radio frequency signals are radiated for reception by user equipment (UEs). Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits them to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, this involves, among other things, summing uplink signals received from all of the multiple access points in order to produce the base station signal provided to each base station. In this way, the DAS increases the coverage area for the uplink capacity provided by the base stations.

A DAS can use either digital transport, analog transport, or combinations of digital and analog transport for generating and communicating the transport signals between the central access nodes, the access points, and any transport expansion nodes.

### SUMMARY

In one aspect, a method for using a radio intelligent controller with a distributed antenna system (DAS) is described. The method includes receiving fronthaul information via an E2 interface from one or more nodes of the DAS included in a system. The method further includes automatically generating one or more operational parameters for one or more components of the system that includes the DAS based on the fronthaul information received via an E2 interface from the one or more nodes of the DAS. The method further includes adjusting operation of one or more components of the system that includes the DAS based on the one or more automatically generated operational parameters for the one or more components of the system that includes the DAS.

In another aspect, a system is described. The system includes a master unit communicatively coupled to one or more baseband unit entities and a plurality of radio units communicatively coupled to the master unit, wherein the plurality of radio units is located remotely from the master unit. The system further includes a radio intelligent controller communicatively coupled to the master unit. The radio intelligent controller is configured to receive fronthaul information via an E2 interface from the master unit. The radio intelligent controller is further configured to automatically generate one or more operational parameters for one or more components of the system based on the fronthaul information received via an E2 interface from the master unit. The radio intelligent controller is further configured to adjust operation of one or more components of the system based on the one or more automatically generated operational parameters.

In another aspect, a system is described. The system includes a fronthaul multiplexer/fronthaul gateway (FHM/FHGW) communicatively coupled to one or more baseband unit entities. The system further includes one or more radio units communicatively coupled to the FHM/FHGW, wherein the one or more radio units are located remotely from the FHM/FHGW. The system further includes a radio intelligent controller communicatively coupled to the FHM/FHGW. The radio intelligent controller is configured to receive fronthaul information via an E2 interface from the FHM/FHGW. The radio intelligent controller is further configured to automatically generate one or more operational parameters for one or more components of the system based on the fronthaul information received via an E2 interface from the FHM/FHGW. The radio intelligent controller is further configured to adjust operation of one or more components of the system based on the one or more automatically generated operational parameters.

### BRIEF DESCRIPTION OF THE DRAWINGS

Comprehension of embodiments of the invention is facilitated by reading the following detailed description in conjunction with the annexed drawings, in which:

FIG. 1A is a block diagram illustrating an exemplary embodiment of a DAS that is configured to serve one or more base stations;

FIG. 1B illustrates another exemplary embodiment of a DAS;

FIG. 1C illustrates another exemplary embodiment of a DAS;

FIG. 1D illustrates another exemplary embodiment of a DAS;

FIG. 2A illustrates another exemplary embodiment of a DAS;

FIG. 2B illustrates another exemplary embodiment of a DAS;

FIG. 2C illustrates another exemplary embodiment of a DAS;

FIG. 2D illustrates another exemplary embodiment of a DAS;

FIG. 3 illustrates a flow diagram of an example method for using a radio intelligent controller with a DAS;

FIG. 4 illustrates a flow diagram of an example method for using a radio intelligent controller with a DAS; and

FIG. 5 illustrates an energy savings operation for a DAS.

### DETAILED DESCRIPTION

In the following detailed description, reference is made to the accompanying drawings that form a part hereof, and in which is shown by way of illustration specific illustrative embodiments. However, it is to be understood that other embodiments may be used, and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

In a fifth generation (5G) New Radio (NR) network, digital signals may be distributed via a digital DAS and/or fronthaul multiplexer/fronthaul gateway (FHM/FHGW) to overcome coverage or capacity constraints. These digitals signals are distributed via a packet transport network that has throughput and latency limitations (for example, using enhanced Common Public Radio Interface (“eCPRI”)). The user data, control, and signaling messages (for example, eCPRI) exchanged carry information such as channel conditions, transmit power, delay, and the like between nodes. Typically, for a 5G NR network that utilizes a DAS and/or FHM/FHGW for distributing fronthaul signals, the nodes of the DAS and/or FHM/FHGW are static and there is no definition regarding how the nodes should operate or adjust operation based on real-time conditions in 3rd Generation Partnership Projection (3GPP) or Open Radio Access Network (O-RAN) specifications.

While the problems described above involve 5G NR systems, similar problems exist in LTE. Therefore, although the following embodiments are primarily described as being implemented for use to provide 5G NR service, it is to be understood the techniques described here can be used with other wireless interfaces (for example, fourth generation (4G) Long-Term Evolution (LTE) service) and references to “gNB” can be replaced with the more general term “base station” or “base station entity” and/or a term particular to the alternative wireless interfaces (for example, “enhanced NodeB” or “eNB”). Furthermore, it is also to be understood that 5G NR embodiments can be used in both standalone and non-standalone modes (or other modes developed in the future), and the following description is not intended to be limited to any particular mode. Also, unless explicitly indicated to the contrary, references to “layers” or a “layer” (for example, Layer-1, Layer-2, Layer-3, the Physical Layer, the MAC Layer, etc.) set forth herein refer to layers of the wireless interface (for example, 5G NR or 4G LTE) used for wireless communication between a base station and user equipment).

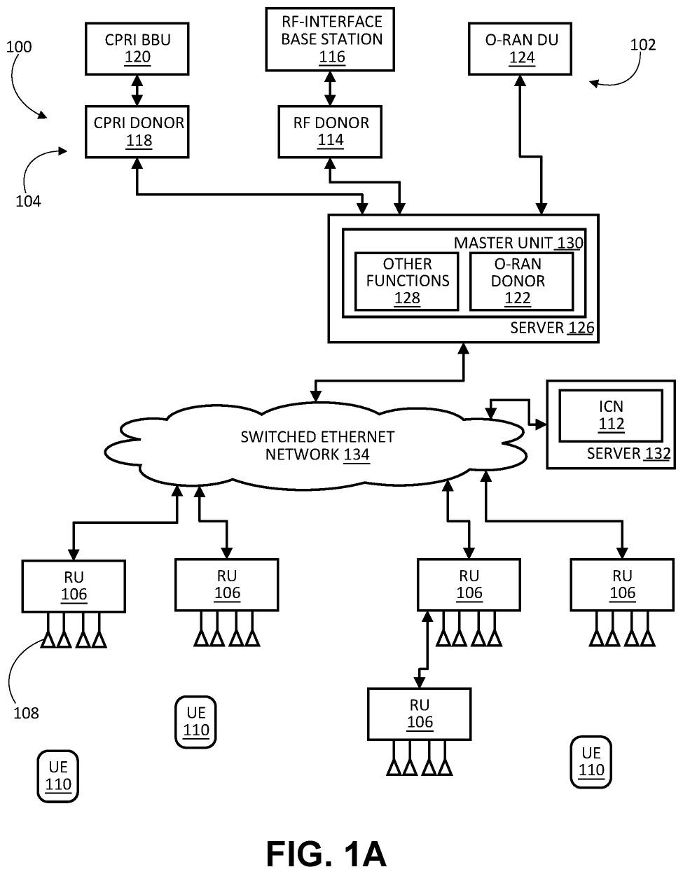

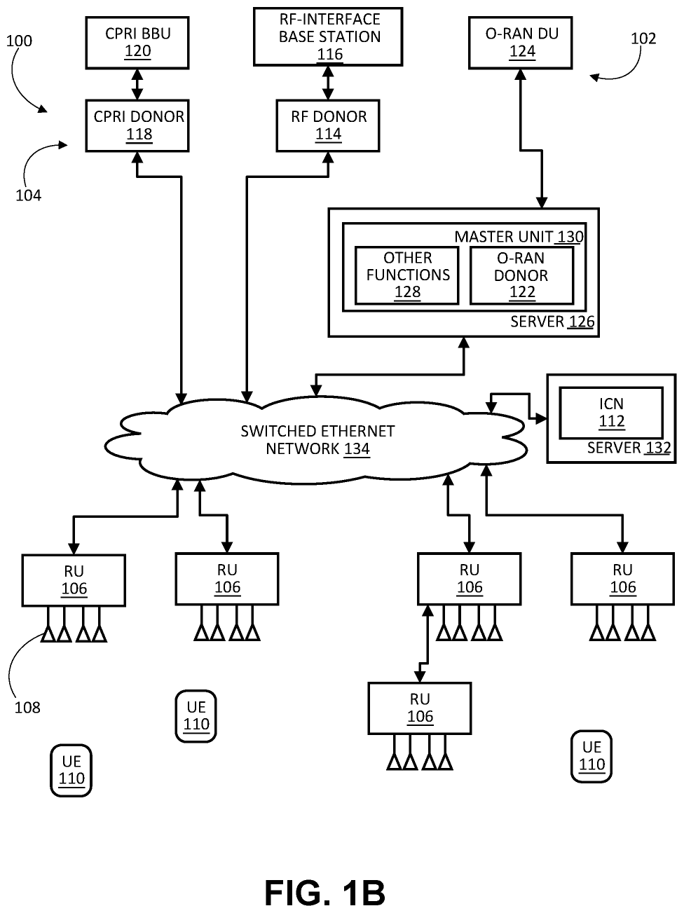

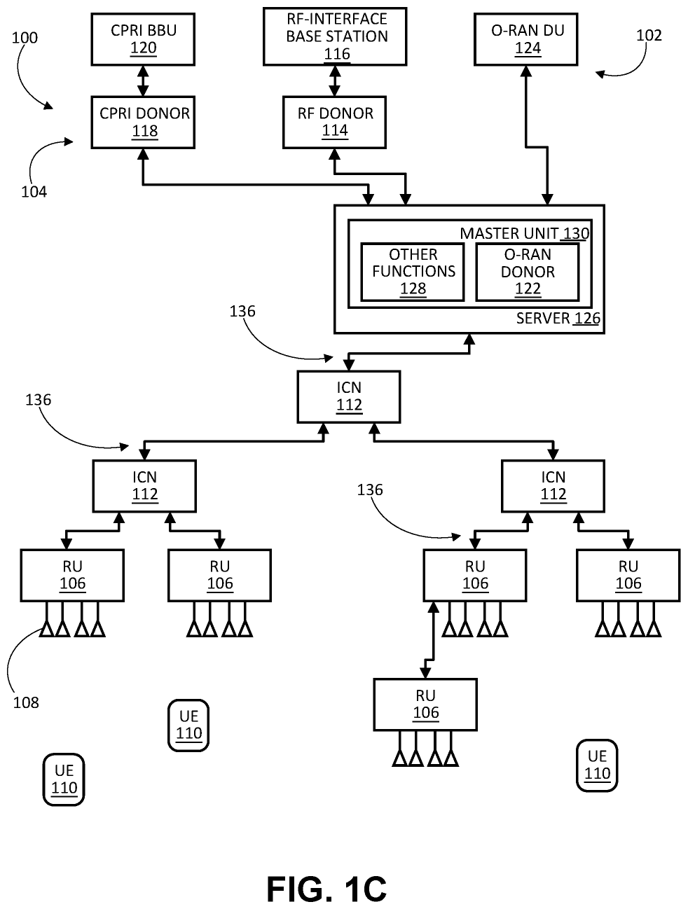

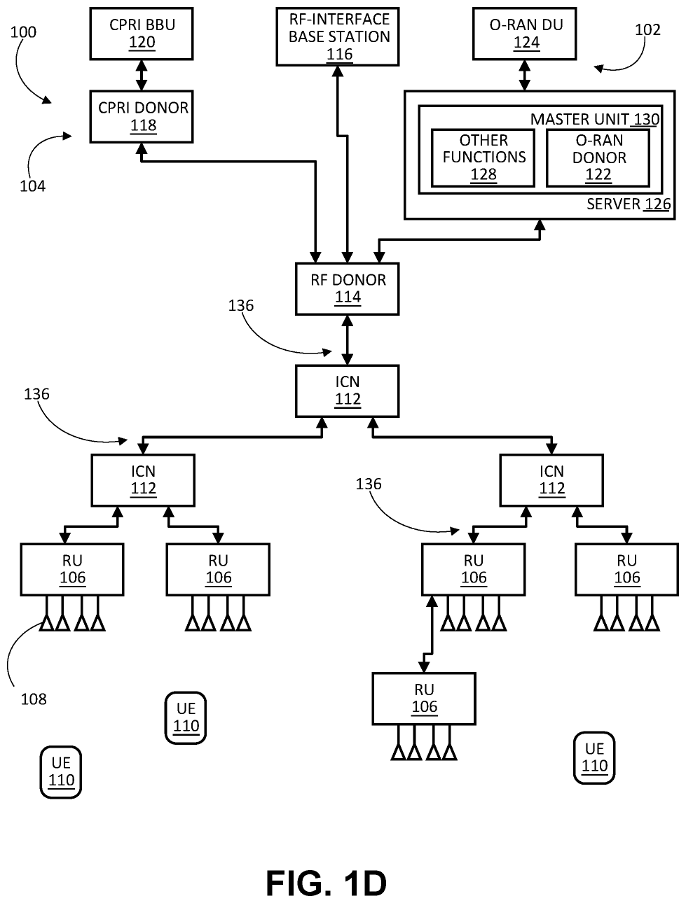

FIG. 1A is a block diagram illustrating an exemplary embodiment of a distributed antenna system (DAS) 100 that is configured to serve one or more base stations 102. In the exemplary embodiment shown in FIG. 1A, the DAS 100 includes one or more donor units 104 that are used to couple the DAS 100 to the base stations 102. The DAS 100 also includes a plurality of remotely located radio units (RUs) 106 (also referred to as “antenna units,” “access points,” “remote units,” or “remote antenna units”). The RUs 106 are communicatively coupled to the donor units 104.

Each RU 106 includes, or is otherwise associated with, a respective set of coverage antennas 108 via which downlink analog RF signals can be radiated to user equipment (UEs) 110 and via which uplink analog RF signals transmitted by UEs 110 can be received. The DAS 100 is configured to serve each base station 102 using a respective subset of RUs 106 (which may include less than all of the RUs 106 of the DAS 100). Also, the subsets of RUs 106 used to serve the base stations 102 may differ from base station 102 to base station 102. The subset of RUs 106 used to serve a given base station 102 is also referred to here as the “simulcast zone” for that base station 102. In general, the wireless coverage of a base station 102 served by the DAS 100 is improved by radiating a set of downlink RF signals for that base station 102 from the coverage antennas 108 associated with the multiple RUs 106 in that base station's simulcast zone and by producing a single “combined” set of uplink base station signals or data that is provided to that base station 102. The single combined set of uplink base station signals or data is produced by a combining or summing process that uses inputs derived from the uplink RF signals received via the coverage antennas 108 associated with the RUs 106 in that base station's simulcast zone.

The DAS 100 can also include one or more intermediary combining nodes (ICNs) 112 (also referred to as “expansion” units or nodes). For each base station 102 served by a given ICN 112, the ICN 112 is configured to receive a set of uplink transport data for that base station 102 from a group of “southbound” entities (that is, from RUs 106 and/or other ICNs 112) and generate a single set of combined uplink transport data for that base station 102, which the ICN 112 transmits “northbound” towards the donor unit 104 serving that base station 102. The single set of combined uplink transport data for each served base station 102 is produced by a combining or summing process that uses inputs derived from the uplink RF signals received via the coverage antennas 108 of any southbound RUs 106 included in that base station's simulcast zone. As used here, “southbound” refers to traveling in a direction “away,” or being relatively “farther,” from the donor units 104 and base stations 102, and “northbound” refers to traveling in a direction “towards,” or being relatively “closer” to, the donor units 104 and base stations 102.

In some configurations, each ICN 112 also forwards downlink transport data to the group of southbound RUs 106 and/or ICNs 112 served by that ICN 112. Generally, ICNs 112 can be used to increase the number of RUs 106 that can be served by the donor units 104 while reducing the processing and bandwidth load relative to having the additional RUs 106 communicate directly with each such donor unit 104.

Also, one or more RUs 106 can be configured in a “daisy-chain” or “ring” configuration in which transport data for at least some of those RUs 106 is communicated via at least one other RU 106. Each RU 106 would also perform the combining or summing process for any base station 102 that is served by that RU 106 and one or more of the southbound entities subtended from that RU 106. Such a RU 106 also forwards northbound all other uplink transport data received from its southbound entities.

The DAS 100 can include various types of donor units 104. One example of a donor unit 104 is an RF donor unit 114 that is configured to couple the DAS 100 to a base station 116 using the external analog radio frequency (RF) interface of the base station 116 that would otherwise be used to couple the base station 116 to one or more antennas (if the DAS 100 were not being used). This type of base station 116 is also referred to here as an “RF-interface” base station 116. An RF-interface base station 116 can be coupled to a corresponding RF donor unit 114 by coupling each antenna port of the base station 116 to a corresponding port of the RF donor unit 114.

Each RF donor unit 114 serves as an interface between each served RF-interface base station 116 and the rest of the DAS 100 and receives downlink base station signals from, and outputs uplink base station signals to, each served RF-interface base station 116. Each RF donor unit 114 performs at least some of the conversion processing necessary to convert the base station signals to and from the digital fronthaul interface format natively used in the DAS 100 for communicating time-domain baseband data. The downlink and uplink base station signals communicated between the RF-interface base station 116 and the donor unit 114 are analog RF signals. Also, in this example, the digital fronthaul interface format natively used in the DAS 100 for communicating time-domain baseband data can comprise the O-RAN fronthaul interface, a CPRI or enhanced CPRI (eCPRI) digital fronthaul interface format, or a proprietary digital fronthaul interface format (though other digital fronthaul interface formats can also be used).

Another example of a donor unit 104 is a digital donor unit that is configured to communicatively couple the DAS 100 to a baseband entity using a digital baseband fronthaul interface that would otherwise be used to couple the baseband entity to a radio unit (if the DAS 100 were not being used). In the example shown in FIG. 1A, two types of digital door units are shown.

The first type of digital donor unit comprises a digital donor unit 118 that is configured to communicatively couple the DAS 100 to a baseband unit (BBU) 120 using a time-domain baseband fronthaul interface implemented in accordance with a Common Public Radio Interface (“CPRI”) specification. This type of digital donor unit 118 is also referred to here as a “CPRI” donor unit 118, and this type of BBU 120 is also referred to here as a CPRI BBU 120. For each CPRI BBU 120 served by a CPRI donor unit 118, the CPRI donor unit 118 is coupled to the CPRI BBU 120 using the CPRI digital baseband fronthaul interface that would otherwise be used to couple the CPRI BBU 120 to a CPRI remote radio head (RRH) (if the DAS 100 were not being used). A CPRI BBU 120 can be coupled to a corresponding CPRI donor unit 118 via a direct CPRI connection.

Each CPRI donor unit 118 serves as an interface between each served CPRI BBU 120 and the rest of the DAS 100 and receives downlink base station signals from, and outputs uplink base station signals to, each CPRI BBU 120. Each CPRI donor unit 118 performs at least some of the conversion processing necessary to convert the CPRI base station data to and from the digital fronthaul interface format natively used in the DAS 100 for communicating time-domain baseband data. The downlink and uplink base station signals communicated between each CPRI BBU 120 and the CPRI donor unit 118 comprise downlink and uplink fronthaul data generated and formatted in accordance with the CPRI baseband fronthaul interface.

The second type of digital donor unit comprises a digital donor unit 122 that is configured to communicatively couple the DAS 100 to a BBU 124 using a frequency-domain baseband fronthaul interface implemented in accordance with a O-RAN Alliance specification. The acronym “O-RAN” is an abbreviation for “Open Radio Access Network.” This type of digital donor unit 122 is also referred to here as an “O-RAN” donor unit 122, and this type of BBU 124 is typically an O-RAN distributed unit (DU) and is also referred to here as an O-RAN DU 124. For each O-RAN DU 124 served by a O-RAN donor unit 122, the O-RAN donor unit 122 is coupled to the O-DU 124 using the O-RAN digital baseband fronthaul interface that would otherwise be used to couple the O-RAN DU 124 to a O-RAN RU (if the DAS 100 were not being used). An O-RAN DU 124 can be coupled to a corresponding O-RAN donor unit 122 via a switched Ethernet network. Alternatively, an O-RAN DU 124 can be coupled to a corresponding O-RAN donor unit 122 via a direct Ethernet or CPRI connection.

Each O-RAN donor unit 122 serves as an interface between each served O-RAN DU 124 and the rest of the DAS 100 and receives downlink base station signals from, and outputs uplink base station signals to, each O-RAN DU 124. Each O-RAN donor unit 122 performs at least some of any conversion processing necessary to convert the base station signals to and from the digital fronthaul interface format natively used in the DAS 100 for communicating frequency-domain baseband data. The downlink and uplink base station signals communicated between each O-RAN DU 124 and the O-RAN donor unit 122 comprise downlink and uplink fronthaul data generated and formatted in accordance with the O-RAN baseband fronthaul interface, where the user-plane data comprises frequency-domain baseband IQ data. Also, in this example, the digital fronthaul interface format natively used in the DAS 100 for communicating O-RAN fronthaul data is the same O-RAN fronthaul interface used for communicating base station signals between each O-RAN DU 124 and the O-RAN donor unit 122, and the “conversion” performed by each O-RAN donor unit 122 (and/or one or more other entities of the DAS 100) includes performing any needed “multicasting” of the downlink data received from each O-RAN DU 124 to the multiple RUs 106 in a simulcast zone for that O-RAN DU 124 (for example, by communicating the downlink fronthaul data to an appropriate multicast address and/or by copying the downlink fronthaul data for communication over different fronthaul links) and performing any need combining or summing of the uplink data received from the RUs 106 to produce combined uplink data provided to the O-RAN DU 124. It is to be understood that other digital fronthaul interface formats can also be used.

In general, the various base stations 102 are configured to communicate with a core network (not shown) of the associated wireless operator using an appropriate backhaul network (typically, a public wide area network such as the Internet). Also, the various base stations 102 may be from multiple, different wireless operators and/or the various base stations 102 may support multiple, different wireless protocols and/or RF bands.

In general, for each base station 102, the DAS 100 is configured to receive a set of one or more downlink base station signals from the base station 102 (via an appropriate donor unit 104), generate downlink transport data derived from the set of downlink base station signals, and transmit the downlink transport data to the RUs 106 in the base station's simulcast zone. For each base station 102 served by a given RU 106, the RU 106 is configured to receive the downlink transport data transmitted to it via the DAS 100 and use the received downlink transport data to generate one or more downlink analog radio frequency signals that are radiated from one or more coverage antennas 108 associated with that RU 106 for reception by user equipment 110. In this way, the DAS 100 increases the coverage area for the downlink capacity provided by the base stations 102. Also, for any southbound entities (for example, southbound RUs 106 or ICNs 112) coupled to the RU 106 (for example, in a daisy chain or ring architecture), the RU 106 forwards any downlink transport data intended for those southbound entities towards them.

For each base station 102 served by a given RU 106, the RU 106 is configured to receive one or more uplink radio frequency signals transmitted from the user equipment 110. These signals are analog radio frequency signals and are received via the coverage antennas 108 associated with that RU 106. The RU 106 is configured to generate uplink transport data derived from the one or more remote uplink radio frequency signals received for the served base station 102 and transmit the uplink transport data northbound towards the donor unit 104 coupled to that base station 102.

For each base station 102 served by the DAS 100, a single “combined” set of uplink base station signals or data is produced by a combining or summing process that uses inputs derived from the uplink RF signals received via the RUs 106 in that base station's simulcast zone. The resulting final single combined set of uplink base station signals or data is provided to the base station 102. This combining or summing process can be performed in a centralized manner in which the combining or summing process is performed by a single unit of the DAS 100 (for example, a donor unit 104 or master unit 130). This combining or summing process can also be performed in a distributed or hierarchical manner in which the combining or summing process is performed by multiple units of the DAS 100 (for example, a donor unit 104 (or master unit 130) and one or more ICNs 112 and/or RUs 106). Each unit of the DAS 100 that performs the combining or summing process for a given base station 102 receives uplink transport data from that unit's southbound entities and uses that data to generate combined uplink transport data, which the unit transmits northbound towards the base station 102. The generation of the combined uplink transport data involves, among other things, extracting in-phase and quadrature (IQ) data from the received uplink transport data and performing a combining or summing process using any uplink IQ data for that base station 102 in order to produce combined uplink IQ data.

Some of the details regarding how base station signals or data are communicated and transport data is produced vary based on which type of base station 102 is being served. In the case of an RF-interface base station 116, the associated RF donor unit 114 receives analog downlink RF signals from the RF-interface base station 116 and, either alone or in combination with one or more other units of the DAS 100, converts the received analog downlink RF signals to the digital fronthaul interface format natively used in the DAS 100 for communicating time-domain baseband data (for example, by digitizing, digitally down-converting, and filtering the received analog downlink RF signals in order to produce digital baseband IQ data and formatting the resulting digital baseband IQ data into packets), and communicates the resulting packets of downlink transport data to the various RUs 106 in the simulcast zone of that base station 116. The RUs 106 in the simulcast zone for that base station 116 receive the downlink transport data and use it to generate and radiate downlink RF signals as described above. In the uplink, either alone or in combination with one or more other units of the DAS 100, the RF donor unit 114 generates a set of uplink base station signals from uplink transport data received by the RF donor unit 114 (and/or the other units of the DAS 100 involved in this process). The set of uplink base station signals is provided to the served base station 116. The uplink transport data is derived from the uplink RF signals received at the RUs 106 in the simulcast zone of the served base station 116 and communicated in packets.

In the case of a CPRI BBU 120, the associated CPRI digital donor unit 118 receives CPRI downlink fronthaul data from the CPRI BBU 120 and, either alone or in combination with another unit of the DAS 100, converts the received CPRI downlink fronthaul data to the digital fronthaul interface format natively used in the DAS 100 for communicating time-domain baseband data (for example, by re-sampling, synchronizing, combining, separating, gain adjusting, etc. the CPRI baseband IQ data, and formatting the resulting baseband IQ data into packets), and communicates the resulting packets of downlink transport data to the various RUs 106 in the simulcast zone of that CPRI BBU 120. The RUs 106 in the simulcast zone of that CPRI BBU 120 receive the packets of downlink transport data and use them to generate and radiate downlink RF signals as described above. In the uplink, either alone or in combination with one or more other units of the DAS 100, the CPRI donor unit 118 generates uplink base station data from uplink transport data received by the CPRI donor unit 118 (and/or the other units of the DAS 100 involved in this process). The resulting uplink base station data is provided to that CPRI BBU 120. The uplink transport data is derived from the uplink RF signals received at the RUs 106 in the simulcast zone of the CPRI BBU 120.

In the case of an O-RAN DU 124, the associated O-RAN donor unit 122 receives packets of O-RAN downlink fronthaul data (that is, O-RAN user-plane and control-plane messages) from each O-RAN DU 124 coupled to that O-RAN digital donor unit 122 and, either alone or in combination with another unit of the DAS 100, converts (if necessary) the received packets of O-RAN downlink fronthaul data to the digital fronthaul interface format natively used in the DAS 100 for communicating O-RAN baseband data, and communicates the resulting packets of downlink transport data to the various RUs 106 in a simulcast zone for that ORAN DU 124. The RUs 106 in the simulcast zone of each O-RAN DU 124 receive the packets of downlink transport data and use them to generate and radiate downlink RF signals as described above. In the uplink, either alone or in combination with one or more other units of the DAS 100, the O-RAN donor unit 122 generates packets of uplink base station data from uplink transport data received by the O-RAN donor unit 122 (and/or the other units of the DAS 100 involved in this process). The resulting packets of uplink base station data are provided to the O-RAN DU 124. The uplink transport data is derived from the uplink RF signals received at the RUs 106 in the simulcast zone of the served O-RAN DU 124 and communicated in packets.

In one implementation, one of the units of the DAS 100 is also used to implement a “master” timing entity for the DAS 100 (for example, such a master timing entity can be implemented as a part of a master unit 130 described below). In another example, a separate, dedicated timing master entity (not shown) is provided within the DAS 100. In either case, the master timing entity synchronizes itself to an external timing master entity (for example, a timing master associated with one or more of the O-DUs 124) and, in turn, that entity serves as a timing master entity for the other units of the DAS 100. A time synchronization protocol (for example, the Institute of Electrical and Electronics Engineers (IEEE) 1588 Precision Time Protocol (PTP), the Network Time Protocol (NTP), or the Synchronous Ethernet (SyncE) protocol) can be used to implement such time synchronization.

A management system (not shown) can be used to manage the various nodes of the DAS 100. In one implementation, the management system communicates with a predetermined “master” entity for the DAS 100 (for example, the master unit 130 described below), which in turns forwards or otherwise communicates with the other units of the DAS 100 for management-plane purposes. In another implementation, the management system communicates with the various units of the DAS 100 directly for management-plane purposes (that is, without using a master entity as a gateway).

Each base station 102 (including each RF-interface base station 116, CPRI BBU 120, and O-RAN DU 124), donor unit 104 (including each RF donor unit 114, CPRI donor unit 118, and O-RAN donor unit 122), RU 106, ICN 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.). Such entities can be implemented in other ways.

The DAS 100 can be implemented in a virtualized manner or a non-virtualized manner. When implemented in a virtualized manner, one or more nodes, units, or functions of the DAS 100 are implemented using one or more virtual network functions (VNFs) executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). More specifically, in the exemplary embodiment shown in FIG. 1A, each O-RAN donor unit 122 is implemented as a VNF running on a server 126. The server 126 can execute other VNFs 128 that implement other functions for the DAS 100 (for example, fronthaul, management plane, and synchronization plane functions). The various VNFs executing on the server 126 are also referred to here as “master unit” functions 130 or, collectively, as the “master unit” 130. Also, in the exemplary embodiment shown in FIG. 1A, each ICN 112 is implemented as a VNF running on a server 132.

The RF donor units 114 and CPRI donor units 118 can be implemented as cards (for example, Peripheral Component Interconnect (PCI) Cards) that are inserted in the server 126. Alternatively, the RF donor units 114 and CPRI donor units 118 can be implemented as separate devices that are coupled to the server 126 via dedicated Ethernet links or via a switched Ethernet network (for example, the switched Ethernet network 134 described below).

In the exemplary embodiment shown in FIG. 1A, the donor units 104, RUs 106, and ICNs 112 are communicatively coupled to one another via a switched Ethernet network 134. Also, in the exemplary embodiment shown in FIG. 1A, an O-RAN DU 124 can be coupled to a corresponding O-RAN donor unit 122 via the same switched Ethernet network 134 used for communication within the DAS 100 (though each O-RAN DU 124 can be coupled to a corresponding O-RAN donor unit 122 in other ways). In the exemplary embodiment shown in FIG. 1A, the downlink and uplink transport data communicated between the units of the DAS 100 is formatted as O-RAN data that is communicated in Ethernet packets over the switched Ethernet network 134.

In the exemplary embodiment shown in FIG. 1A, the RF donor units 114 and CPRI donor units 118 are coupled to the RUs 106 and ICNs 112 via the master unit 130.

In the downlink, the RF donor units 114 and CPRI donor units 118 provide downlink time-domain baseband IQ data to the master unit 130. The master unit 130 generates downlink O-RAN user-plane messages containing downlink baseband IQ that is either the time-domain baseband IQ data provided from the donor units 114 and 118 or is derived therefrom (for example, where the master unit 130 converts the received time-domain baseband IQ data into frequency-domain baseband IQ data). The master unit 130 also generates corresponding downlink O-RAN control-plane messages for those O-RAN user-plane messages. The resulting downlink O-RAN user-plane and control-plane messages are communicated (multicasted) to the RUs 106 in the simulcast zone of the corresponding base station 102 via the switched Ethernet network 134.

In the uplink, for each RF-interface base station 116 and CPRI BBU 120, the master unit 130 receives O-RAN uplink user-plane messages for the base station 116 or CPRI BBU 120 and performs a combining or summing process using the uplink baseband IQ data contained in those messages in order to produce combined uplink baseband IQ data, which is provided to the appropriate RF donor unit 114 or CPRI donor unit 118. The RF donor unit 114 or CPRI donor unit 118 uses the combined uplink baseband IQ data to generate a set of base station signals or CPRI data that is communicated to the corresponding RF-interface base station 116 or CPRI BBU 120. If time-domain baseband IQ data has been converted into frequency-domain baseband IQ data for transport over the DAS 100, the donor unit 114 or 118 also converts the combined uplink frequency-domain IQ data into combined uplink time-domain IQ data as part of generating the set of base station signals or CPRI data that is communicated to the corresponding RF-interface base station 116 or CPRI BBU 120.

In the exemplary embodiment shown in FIG. 1A, the master unit 130 (more specifically, the O-RAN donor unit 122) receives downlink O-RAN user-plane and control-plane messages from each served O-RAN DU 124 and communicates (multicasts) them to the RUs 106 in the simulcast zone of the corresponding O-RAN DU 124 via the switched Ethernet network 134. In the uplink, the master unit 130 (more specifically, the O-RAN donor unit 122) receives O-RAN uplink user-plane messages for each served O-RAN DU 124 and performs a combining or summing process using the uplink baseband IQ data contained in those messages in order to produce combined uplink IQ data. The O-RAN donor unit 122 produces O-RAN uplink user-plane messages containing the combined uplink baseband IQ data and communicates those messages to the O-RAN DU 124.

In the exemplary embodiment shown in FIG. 1A, only uplink transport data is communicated using the ICNs 112, and downlink transport data is communicated from the master unit 130 to the RUs 106 without being forwarded by, or otherwise communicated using, the ICNs 112.

FIG. 1B illustrates another exemplary embodiment of a DAS 100. The DAS 100 shown in FIG. 1B is the same as the DAS 100 shown in FIG. 1A except as described below. In the exemplary embodiment shown in FIG. 1B, the RF donor units 114 and CPRI donor units 118 are coupled directly to the switched Ethernet network 134 and not via the master unit 130, as is the case in the embodiment shown in FIG. 1A.

As described above, in the exemplary embodiment shown in FIG. 1A, the master unit 130 performs some transport functions related to serving the RF-interface base stations 116 and CPRI BBUs 120 coupled to the donor units 114 and 118. In the exemplary embodiment shown in FIG. 1B, the RF donor units 114 and CPRI donor units 118 perform those transport functions (that is, the RF donor units 114 and CPRI donor units 118 perform all of the transport functions related to serving the RF-interface base stations 116 and CPRI BBUs 120, respectively).

FIG. 1C illustrates another exemplary embodiment of a DAS 100. The DAS 100 shown in FIG. 1C is the same as the DAS 100 shown in FIG. 1A except as described below. In the exemplary embodiment shown in FIG. 1C, the donor units 104, RUs 106 and ICNs 112 are communicatively coupled to one another via point-to-point Ethernet links 136 (instead of a switched Ethernet network). Also, in the exemplary embodiment shown in FIG. 1C, an O-RAN DU 124 can be coupled to a corresponding O-RAN donor unit 122 via a switched Ethernet network (not shown in FIG. 1C), though that switched Ethernet network is not used for communication within the DAS 100. In the exemplary embodiment shown in FIG. 1C, the downlink and uplink transport data communicated between the units of the DAS 100 is communicated in Ethernet packets over the point-to-point Ethernet links 136.

For each southbound point-to-point Ethernet link 136 that couples a master unit 130 to an ICN 112, the master unit 130 assembles downlink transport frames and communicates them in downlink Ethernet packets to the ICN 112 over the point-to-point Ethernet link 136. For each point-to-point Ethernet link 136, each downlink transport frame multiplexes together downlink time-domain baseband IQ data and Ethernet data that needs to be communicated to southbound RUs 106 and ICNs 112 that are coupled to the master unit 130 via that point-to-point Ethernet link 136. The downlink time-domain baseband IQ data is sourced from one or more RF donor units 114 and/or CPRI donor units 118. The Ethernet data comprises downlink user-plane and control-plane O-RAN fronthaul data sourced from one or more O-RAN donor units 122 and/or management-plane data sourced from one or more management entities for the DAS 100. That is, this Ethernet data is encapsulated into downlink transport frames that are also used to communicate downlink time-domain baseband IQ data and this Ethernet data is also referred to here as “encapsulated” Ethernet data. The resulting downlink transport frames are communicated in the payload of downlink Ethernet packets communicated from the master unit 130 to the ICN 112 over the point-to-point Ethernet link 136. The Ethernet packets into which the encapsulated Ethernet data is encapsulated are also referred to here as “transport” Ethernet packets.

Each ICN 112 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. Any encapsulated Ethernet data that is intended for the ICN 112 (for example, management-plane Ethernet data) is processed by the ICN 112.

For each southbound point-to-point Ethernet link 136 coupled to the ICN 112, the ICN 112 assembles downlink transport frames and communicates them in downlink Ethernet packets to the southbound entities subtended from the ICN 112 via the point-to-point Ethernet link 136. For each southbound point-to-point Ethernet link 136, each downlink transport frame multiplexes together downlink time-domain baseband IQ data and Ethernet data received at the ICN 112 that needs to be communicated to those subtended southbound entities. The resulting downlink transport frames are communicated in the payload of downlink transport Ethernet packets communicated from the ICN 112 to those subtended southbound entities ICN 112 over the point-to-point Ethernet link 136.

Each RU 106 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. As described above, the RU 106 uses any downlink time-domain baseband IQ data and/or downlink O-RAN user-plane and control-plane fronthaul messages to generate downlink RF signals for radiation from the set of coverage antennas 108 associated with that RU 106. The RU 106 processes any management-plane messages communicated to that RU 106 via encapsulated Ethernet data.

Also, for any southbound point-to-point Ethernet link 136 coupled to the RU 106, the RU 106 assembles downlink transport frames and communicates them in downlink Ethernet packets to the southbound entities subtended from the RU 106 via the point-to-point Ethernet link 136. For each southbound point-to-point Ethernet link 136, each downlink transport frame multiplexes together downlink time-domain baseband IQ data and Ethernet data received at the RU 106 that needs to be communicated to those subtended southbound entities. The resulting downlink transport frames are communicated in the payload of downlink transport Ethernet packets communicated from the RU 106 to those subtended southbound entities ICN 112 over the point-to-point Ethernet link 136.

In the uplink, each RU 106 generates uplink time-domain baseband IQ data and/or uplink O-RAN user-plane fronthaul messages for each RF-interface base station 116, CPRI BBU 120, and/or O-RAN DU 124 served by that RU 106 as described above. For each northbound point-to-point Ethernet link 136 of the RU 106, the RU 106 assembles uplink transport frames and communicates them in uplink transport Ethernet packets northbound towards the appropriate master unit 130 via that point-to-point Ethernet link 136. For each northbound point-to-point Ethernet link 136, each uplink transport frame multiplexes together uplink time-domain baseband IQ data originating from that RU 106 and/or any southbound entity subtended from that RU 106 as well as any Ethernet data originating from that RU 106 and/or any southbound entity subtended from that RU 106. In connection with doing this, the RU 106 performs the combining or summing process described above for any base station 102 served by that RU 106 and also by one or more of the subtended entities. (The RU 106 forwards northbound all other uplink data received from those southbound entities.) The resulting uplink transport frames are communicated in the payload of uplink transport Ethernet packets northbound towards the master unit 130 via the associated point-to-point Ethernet link 136.

Each ICN 112 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. For each northbound point-to-point Ethernet link 136 coupled to the ICN 112, the ICN 112 assembles uplink transport frames and communicates them in uplink transport Ethernet packets northbound towards the master unit 130 via that point-to-point Ethernet link 136. For each northbound point-to-point Ethernet link 136, each uplink transport frame multiplexes together uplink time-domain baseband IQ data and Ethernet data received at the ICN 112 that needs to be communicated northbound towards the master unit 130. In connection with doing this, the ICN 112 performs the combining or summing process described above for any base station 102 served by that ICN 112 for which it has received uplink baseband IQ data from multiple entities subtended from that ICN 112. The resulting uplink transport frames are communicated in the payload of uplink transport Ethernet packets communicated northbound towards the master unit 130 over the point-to-point Ethernet link 136.

Each master unit 130 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. Any extracted uplink time-domain baseband IQ data, as well as any uplink O-RAN messages communicated in encapsulated Ethernet, is used in producing a single “combined” set of uplink base station signals or data for the associated base station 102 as described above (which includes performing the combining or summing process). Any other encapsulated Ethernet data (for example, management-plane Ethernet data) is forwarded on towards the respective destination (for example, a management entity).

In the exemplary embodiment shown in FIG. 1C, synchronization-plane messages are communicated using native Ethernet packets (that is, non-encapsulated Ethernet packets) that are interleaved between the transport Ethernet packets.

FIG. 1D illustrates another exemplary embodiment of a DAS 100. The DAS 100 shown in FIG. 1C is the same as the DAS 100 shown in FIG. 1C except as described below. In the exemplary embodiment shown in FIG. 1D, the CPRI donor units 118, O-RAN donor unit 122, and master unit 130 are coupled to the RUs 106 and ICNs 112 via one or more RF units 114. That is, each RF unit 114 performs the transport frame multiplexing and demultiplexing that is described above in connection with FIG. 1C as being performed by the master unit 130.

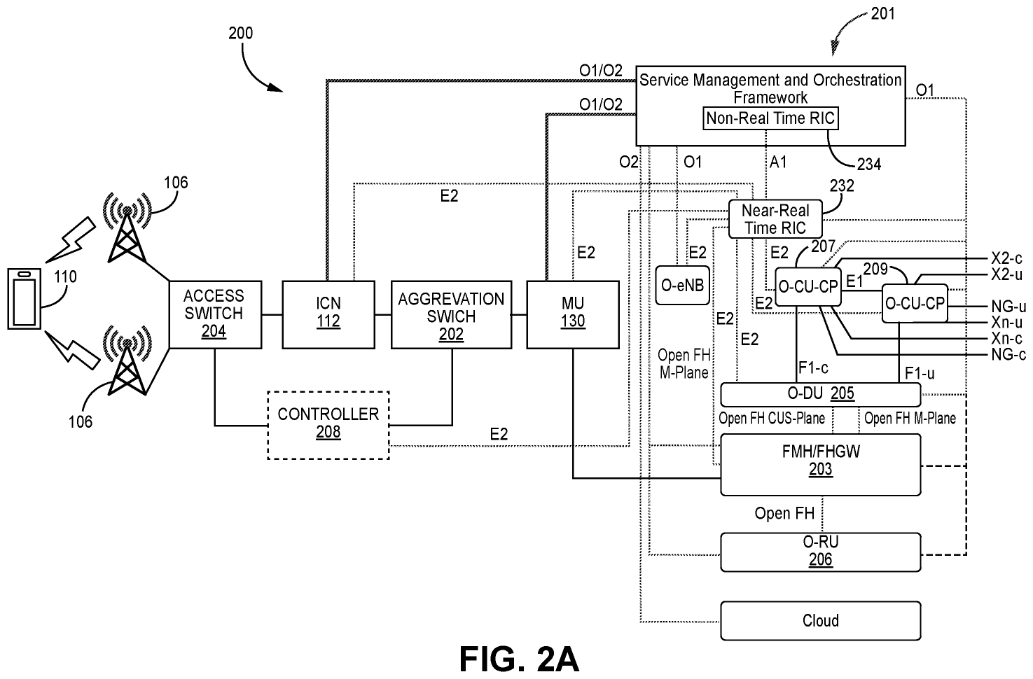

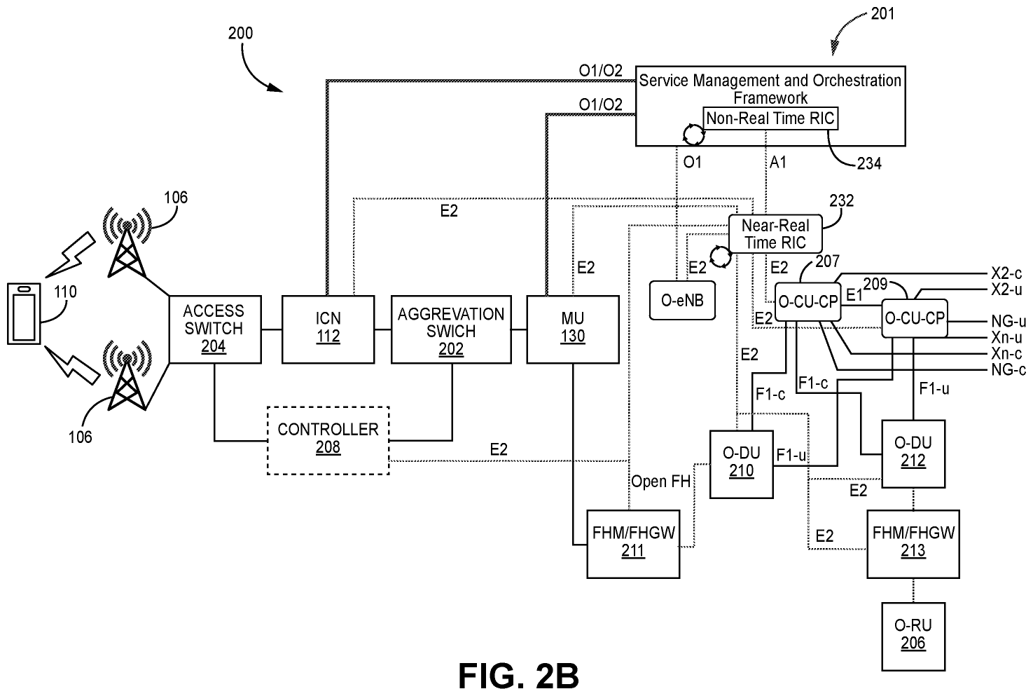

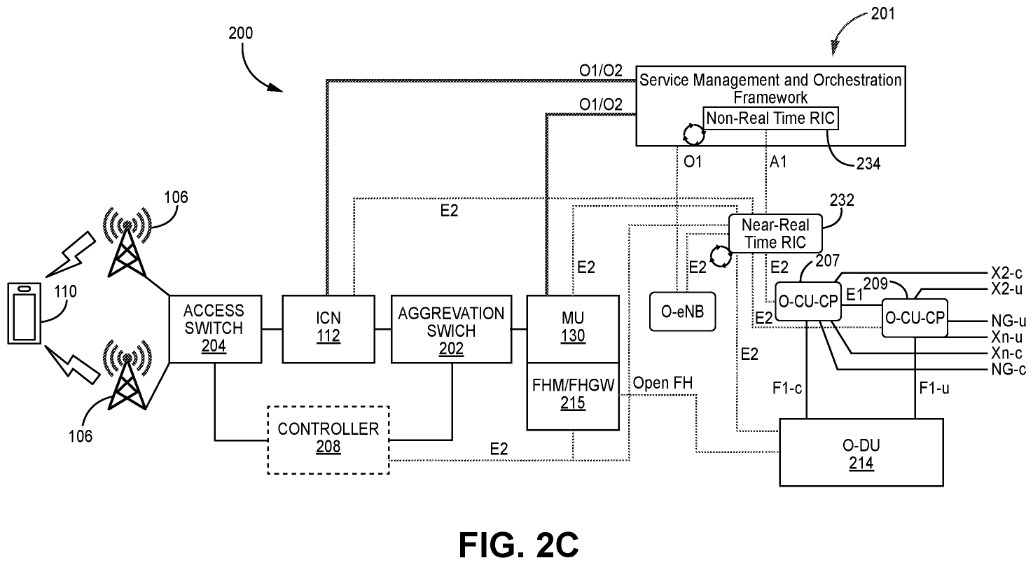

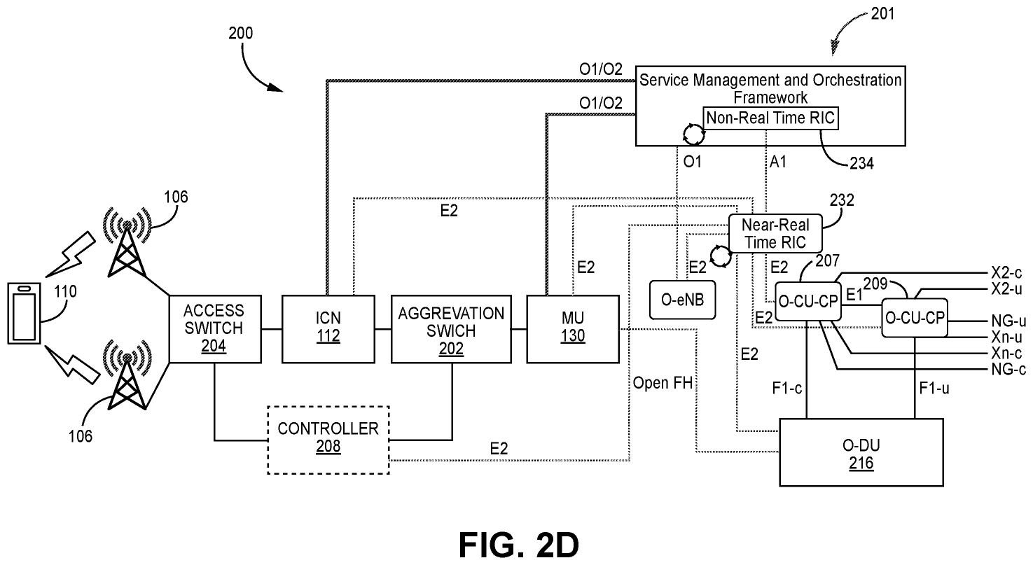

FIG. 2A illustrates another exemplary embodiment of a DAS 200. The DAS 200 shown in FIG. 2A includes similar components to the DAS 100 described above with respect to FIGS. 1A-1D. The functions, structures, and other description of common elements of the DAS 100 discussed above with respect to FIGS. 1A-1D are also applicable to like named features in the DAS 200 shown in FIG. 2A. Further, the like named features included in FIGS. 1A-1D and 2A-2C are numbered similarly. The description of FIG. 2A will focus on the differences from FIGS. 1A-1D.

In the particular example shown in FIG. 2, a system 201 that includes the DAS 200 includes one or more central units (CUs) and one or more distributed units (DUs) communicatively coupled to the DAS 200. The system is implemented in accordance with one or more public standards and specifications. In some examples, the system is implemented using the logical RAN nodes, functional splits, and fronthaul interfaces defined by the Open Radio Access Network (O-RAN) Alliance. In the example shown in FIG. 2A, each CU and DU is implemented as an O-RAN central unit (O-CU) and an O-RAN distributed unit (O-DU) 205, respectively, in accordance with the O-RAN specification. In some examples, each RU is implemented as an O-RAN radio unit (O-RU) 206. In other examples, one or more RUs are implemented as an O-RU 206 and one or more RUs are implemented as a legacy RU.

In the example shown in FIG. 2A, the system includes a single O-CU, which is split between an O-CU-CP 207 that handles control plane functions and an O-CU-UP 209 that handles user plane functions. The O-CU comprises a logical node hosting Packet Data Convergence Protocol (PDCP), Radio Resource Control (RRC), Service Data Adaptation Protocol (SDAP), and other control functions. Therefore, each O-CU implements the gNB controller functions such as the transfer of user data, mobility control, radio access network sharing, positioning, session management, etc. The O-CU(s) control the operation of the O-DUs 205 over an interface (including F1-C and F1-U for the control plane and user plane, respectively).

In the example shown in FIG. 2A, the single O-CU handles control-plane functions, user-plane functions, some non-real-time functions, and/or PDCP processing. The O-CU-CP 207 may communicate with at least one wireless service provider's Next Generation Cores (NGC) using a 5G NG-C interface and the O-CU-UP 209 may communicate with at least one wireless service provider's NGC using a 5G NG-U interface.

Each O-DU 205 comprises a logical node hosting (performing processing for) Radio Link Control (RLC) and Media Access Control (MAC) layers, as well as optionally the upper or higher portion of the Physical (PHY) layer (where the PHY layer is split between the DU and RU). In other words, the O-DUs 205 implement a subset of the gNB functions, depending on the functional split (between O-CU and O-DU 205). In some configurations, the Layer-3 processing (of the 5G air interface) may be implemented in the O-CU and the Layer-2 processing (of the 5G air interface) may be implemented in the O-DU 205.

Each O-RU 206 comprises a logical node hosting the portion of the PHY layer not implemented in the O-DU 205 (that is, the lower portion of the PHY layer) as well as implementing the basic RF and antenna functions. In some examples, the O-RUs 206 may communicate baseband signal data to the O-DUs 205 on Open Fronthaul CUS-plane or Open Fronthaul M-plane interface. In some examples, the O-RU 206 may implement at least some of the Layer-1 and/or Layer-2 processing. In some configurations, the O-RUs 206 may have multiple ETHERNET ports and can communicate with multiple switches.

In the example shown in FIG. 2A, the master unit 130 is communicatively coupled to the O-DU 205 via a Fronthaul Multiplexer/Fronthaul Gateway (FHM/FHGW) 203.

In the example shown in FIG. 2A, the FHM/FHGW 203 is a common element for both the DAS 200 (including the master unit 130, ICN 112, and RUs 106) and the non-DAS system (including the O-RU 206). In some examples, the FHM/FHGW 203 enables a shared cell implementation with multiple RUs. In some examples, the FHM/FHGW 203 is configured to replicate the downlink packet stream (from the O-DU 205) for each RU 106 and the O-RU 206 and use combining/digital summation on the uplink packet stream from the RUs 106 (before sending to the O-DU 205). In FHM mode, the O-DU 205 can send and receive a single packet stream (with a bandwidth of approximately N PRBs) instead of M packet streams (one for each RU with a total bandwidth of approximately N PRBs×M RUs). By reducing the O-DU 205 transmitted and received data to a single stream of N PRBs, the FHM shared cell implementation reduces bandwidth (between the O-DU 205 and multiple RUs).

In the example shown in FIG. 2A, the RUs 106 are communicatively coupled to the O-DUs 205 via the FHM/FHGW 203 and master unit 130, and the master unit 130 is communicatively coupled to the RUs 106 via an aggregation switch 202 and an access switch 204 communicatively coupled to the aggregation switch 202. In the exemplary embodiment shown in FIG. 2A, only uplink transport data is communicated using the ICNs 112, and downlink transport data is communicated from the master unit 130 to the RUs 106 without being forwarded by, or otherwise communicated using, the ICNs 112. It should be understood that other configurations could also be used where the respective ICNs 112 forward downlink transport data to the group of southbound RUs 106 and/or ICNs 112 served by that ICN 112.

The aggregation switch 202 and the access switch 204 can be implemented as physical switches or virtual switches running in a cloud (for example, a radio cloud). In some examples, the aggregation switch 202 and the access switch 204 are SDN capable and enabled switches. In some such examples, the aggregation switch 202 and the access switch 204 are OpenFlow capable and enabled switches. In such examples, the aggregation switch 202 and the access switch 204 are configured to distribute the downlink fronthaul data packets according to forwarding rules in respective flow tables and corresponding flow entries for each respective flow table.

In some examples, the system 201 that includes the DAS 200 further includes one or more controllers 208 configured to control the aggregation switch 202 and the access switch 204. In some examples, the one or more controllers 208 include an SDN controller, and the aggregation switch 202 and the access switch 204 are configured using the SDN controller. In such examples, the SDN controller can be configured to provide the updates to the forwarding rules for the aggregation switch 202 and/or the access switch 204 via the out-of-band control messaging.

In some examples, multicast addressing is used for transporting downlink data from the O-DU 205 to the RUs 106. This is done by defining groups of RUs 106, where each group is assigned a unique multicast IP address. The switches 202, 204 in the DAS 200 are configured to support forwarding downlink data packets using those multicast IP addresses. Each such group is also referred to here as a “multicast group.” The number of RUs 106 that are included in a multicast group is also referred to here as the “size” of the multicast group.

For downlink fronthaul traffic, the aggregation switch 202 is configured to receive downlink fronthaul data packets from the master unit 130 and distribute the downlink fronthaul data packets to the RUs 106 via the access switch 204. In some examples, the aggregation switch 202 receives a single copy of each downlink fronthaul data packet from the master unit 130 for each UE 110. In some examples, each copy is segmented into IP packets that have a destination address that is set to the address of the multicast group associated with that copy. The downlink fronthaul data packet is replicated and transmitted by the aggregation switch 202 and access switch 204 as needed to distribute the downlink fronthaul data packets to the RUs 106 for the particular respective UEs 110.

Although the O-CU (including the O-CU-CP 207 and O-CU-UP 209), O-DU 205, FHM/FHGW 203, master unit 130, ICN 112, and RUs 106, 206 are described as separate logical entities, one or more of them can be implemented together using shared physical hardware and/or software. For example, in the example shown in FIG. 2A, for each cell, the O-CU (including the O-CU-CP 207 and O-CU-UP 209) and O-DU 205 serving that cell could be physically implemented together using shared hardware and/or software, whereas each O-RU 206 would be physically implemented using separate hardware and/or software. Alternatively, the O-CU(s) (including the O-CU-CP 207 and O-CU-UP 209) may be remotely located from the O-DU(s) 205.

The one or more baseband unit entities (for example, O-CU-CP 207, O-CU-UP 209, O-DU 205) can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. For example, the scalable cloud environment is implemented in a distributed manner. That is, the scalable cloud environment is implemented as a distributed scalable cloud environment comprising at least one central cloud, at least one edge cloud, and at least one radio cloud.

In some examples, the O-DUs 205 are implemented as software virtualized entities that are executed in a scalable cloud environment on a cloud worker node under the control of the cloud native software executing on that cloud worker node. In such examples, the O-DUs 205 are communicatively coupled to at least one O-CU-CP 207 and at least one O-CU-UP 209, which can also be implemented as software virtualized entities, and are omitted from FIG. 2 for clarity.

In some examples, each O-DU 205 is implemented as a single virtualized entity executing on a single cloud worker node. In some examples, the at least one O-CU-CP 207 and the at least one O-CU-UP 209 can each be implemented as a single virtualized entity executing on the same cloud worker node or as a single virtualized entity executing on a different cloud worker node. However, it is to be understood that different configurations and examples can be implemented in other ways. For example, the O-CU can be implemented using multiple CU-UP VNFs and using multiple virtualized entities executing on one or more cloud worker nodes. In another example, multiple O-DUs 205 (using multiple virtualized entities executing on one or more cloud worker nodes) can be used to serve a cell, where each of the multiple O-DUs 205 serves a different set of RUs 106. Moreover, it is to be understood that the CU and O-DUs 205 can be implemented in the same cloud (for example, together in the radio cloud or in an edge cloud). Other configurations and examples can be implemented in other ways.

While the example shown in FIG. 2A shows a single O-CU-CP 207, a single O-CU-UP 209, two O-DUs 205, a single FHM/FHGW 203, a single master unit 130, a single aggregation switch 202, a single ICN 112, a single access switch 204, and three RUs 106, 206, it should be understood that this is an example and other numbers of O-CU-CPs 207, O-CU-UPs 209, O-DUs 205, FHM/FHGWs 203, master units 130, aggregation switches 202 (including zero), ICNs 112, access switches 204 (including one), and/or RUs 106, 206 can also be used.

In the example shown in FIG. 2A, the system further includes a non-real time RAN intelligent controller (RIC) 234 and a near-real time RIC 232. The non-real time RIC 234 and the near-real time RIC 232 are separate entities in the O-RAN architecture and serve different purposes. In some examples, the non-real time RIC 234 is implemented as a standalone application in a cloud network. In other examples, the non-real time RIC 234 is integrated with a Device Management System (DMS) or Service Management and Orchestration (SMO) tool. In some examples, the near-real time RIC 232 is implemented as a standalone application in a cloud network. In other examples, the near-real time RIC 232 is embedded in the O-CU. The non-real time RIC 234 and/or the near-real time RIC 232 can also be deployed in other ways.

The non-real time RIC 234 is responsible for non-real time flows in the system (typically greater than or equal to 1 second) and configured to execute one or more machine learning models, which are also referred to as “rApps.” The near-real time RIC 232 is responsible for near-real time flows in the system (typically 10 ms to 1 second) and configured to execute one or more machine learning models, which are also referred to as “xApps.”

In some examples, the machine learning models can be trained, at least in part, offline and/or at a different location from where they are deployed (for example, at the non-real time RIC 234 or SMO for xApps). In some examples, the machine learning models of the near-real time RIC 232 and the non-real time RIC 234 are trained online during operation where they are deployed (at the near-real time RIC 232 or non-real time RIC 234) in addition to, or instead of, the machine learning models being trained offline. The machine learning models can be trained using one or more techniques (for example, reinforcement learning, linear regression, logistic regression, deep neural network, or the like). It should be understood that other techniques can also be used, and the machine learning models can be trained and deployed in other ways such as, for example, any of the ways described in the O-RAN Working Group (WG) 2 Artificial Intelligence (AI) Machine Learning (ML) Technical Report (O-RAN.WG2.AIML-v01.03) (referred to herein as the “O-RAN AIML Technical Report”), which is incorporated herein by reference.

In some examples, the non-real time RIC 234 is configured to provide machine learning models, policy guidance (for example, using a POLICY message as defined in the O-RAN E2AP Specification), and/or enrichment information (for example, to train the machine learning model(s) deployed at the near-real time RIC 232) to the near-real time RIC 232. In some such examples, the non-real time RIC 234 is configured to provide the machine learning models, policy guidance, and/or enrichment information to the near-real time RIC 232 via the A1 interface.

In the example shown in FIG. 2A, the master unit 130 and the ICN 112 are configured to comply with the O-RAN definition of an E2 node. In some examples, the master unit 130 and ICN 112 each include an E2 interface configured to communicate with the near-real time RIC 232 that is similar to the E2 interface as defined for the O-CU or O-DU 205. For example, the master unit 130 and the ICN 112 include E2 interfaces that comply with the required features as defined in the O-RAN Near-Real-time RAN Intelligent Controller, E2 Application Protocol (E2AP) v2.02 (referred to herein as the “O-RAN E2AP Specification”), which is incorporated herein by reference. In the example shown in FIG. 2A, the master unit 130 and ICN 112 are communicatively coupled to the near-real time RIC 232 via a respective E2 interface. In the example shown in FIG. 2A, the near-real time RIC 232 is directly coupled to the master unit 130 and ICN 112. It should be understood that other configurations could also be implemented. For example, the near-real time RIC 232 can also be indirectly coupled to one or more components of the DAS 200 via another component of the DAS 200.

In the example shown in FIG. 2A, the master unit 130 and ICN 112 also include an O1/O2 interface configured to communicate with the non-real time RIC 234 that is similar to the O1/O2 interface as defined for the O-CU or O-DU 205. In the example shown in FIG. 2A, the master unit 130 and ICN 112 are communicatively coupled to the non-real time RIC 234 via the respective O1/O2 interface. In the example shown in FIG. 2A, the non-real time RIC 234 is directly coupled to the master unit 130 and ICN 112. It should be understood that other configurations could also be implemented. For example, the non-real time RIC 234 can also be indirectly coupled to one or more components of the DAS 200 via another component of the DAS 200.

In the example shown in FIG. 2A, the one or more controllers 208 are configured to comply with the O-RAN definition of an E2 node. In some examples, the one or more controllers 208 each include an E2 interface configured to communicate with the near-real time RIC 232 that is similar to the E2 interface as defined for the O-CU or O-DU 205 in the O-RAN E2AP Specification. In the example shown in FIG. 2A, the one or more controllers 208 are communicatively coupled to the near-real time RIC 232 via a respective E2 interface. In the example shown in FIG. 2A, the near-real time RIC 232 is directly coupled to the one or more controllers 208. It should be understood that other configurations could also be implemented. For example, the near-real time RIC 232 can also be indirectly coupled to the one or more controllers 208 via another component of the DAS 200.

An FHM/FHGW in a standard, 3GPP 5G NR network does not include an E2 interface to the near-real time RIC. However, in some situations, such as when using a DAS communicatively coupled to the FHM/FHGW, as shown in FIG. 2A, the FHM/FHGW can provide additional information beyond what is available from the O-CU and the O-DU. In the example shown in FIG. 2A, the FHM/FHGW 203 also is configured to comply with the O-RAN definition of an E2 node. In some examples, the FHM/FHGW 203 includes an E2 interface configured to communicate with the near-real time RIC 232 that is similar to the E2 interface as defined for the O-CU or O-DU 205 in the O-RAN E2AP Specification. In some examples, the E2 interface of the FHM/FHGW 203 is dynamically enabled depending on whether a DAS is communicatively coupled to the FHM/FHGW 203. If there is no DAS communicatively coupled to the FHM/FHGW 203, then the E2 interface of the FHM/FHGW 203 is disabled. However, if there is a DAS communicatively coupled to the FHM/FHGW 203, then the E2 interface of the FHM/FHGW 203 is enabled.

During operation, the master unit 130, the ICN 112, and/or the FHM/FHGW 203 are configured to provide fronthaul information (for example, using a REPORT message as defined in the O-RAN E2AP Specification) to the near-real time RIC 232 via the E2 interface. In some examples, the fronthaul information provided to the near-real time RIC 232 is fronthaul information retrieved from an eCPRI interface at different levels within the DAS. The fronthaul information can include an indication regarding whether IQ data packets are compressed or uncompressed, information from eCPRI headers (for example, stream information, channel information, etc.), eCPRI control/signal message packets (for example, delay or latency measurements, buffer status, transmit power via Real Time Control Data (RTCD)), transport network performance measure (jitter, block error rate (BER), etc.), a number of RUs connected in the downlink, a number of RUs connected in the uplink (for example, for the UE based on the noise floor set), link capacity (for example, including total capacity and the headroom for inbound and outbound at the node), topology information for the cell (for example, hierarchy information, location information, etc. that can be used to estimate the end-to-end number of hops, delay beyond the node, and/or correlate delays from multiple nodes and account for the topology). It should be understood that other fronthaul information could also be sent from the master unit 130, the ICN 112, and/or the FHM/FHGW 203.

In some examples, the master unit 130, the ICN 112, and/or the FHM/FHGW 203 are configured to periodically provide the fronthaul information to the near-real time RIC 232. For example, the master unit 130, the ICN 112, and/or the FHM/FHGW 203 can be configured to provide the fronthaul information at regular time intervals to the near-real time RIC 232. In some examples, the master unit 130, the ICN 112, and/or the FHM/FHGW 203 are configured to provide the fronthaul information to the near-real time RIC 232 based on an event. For example, the event may include receiving a request for the fronthaul information from the near-real time RIC 232, a change in network conditions, etc. It should be understood that the master unit 130, the ICN 112, and/or the FHM/FHGW 203 can provide fronthaul information periodically and based on an event, and the particular time intervals and events are configurable depending on the desired performance of the DAS 200.

The near-real time RIC 232 is configured to receive the fronthaul information provided by the master unit 130, ICN 112, and/or FHM/FHGW 203 via the E2 interface. The near-real time RIC 232 is configured to process the fronthaul information provided via the E2 interface and automatically generate one or more operational parameters for components of the system 201 that includes the DAS 200 based on the fronthaul information provided via the E2 interface from the master unit 130, ICN 112, and/or FHM/FHGW 203. In some such examples, the one or more machine learning models of the near-real time RIC 232 are configured to automatically generate one or more predicted operational parameters for components of the system 201 that includes the DAS 200 based on the fronthaul information provided via the E2 interface from the master unit 130, ICN 112, and/or FHM/FHGW 203. In some examples, the near-real time RIC 232 is configured to use policy guidance provided by the non-real time RIC 234 in addition to, or instead of, generating predicted operational parameters for the components of the system 201 that includes the DAS 200.

The near-real time RIC 232 is configured to adjust operation of one or more components of the system 201 that includes the DAS 200 based on the one or more automatically generated operational parameters for the DAS nodes. The near-real time RIC 232 is configured to adjust operation of one or more components of the system 201 that includes the DAS 200 to improve capacity, coverage, and performance of the system. In some examples, adjusting operation of one or more components of the system 201 that includes the DAS 200 includes a determination of particular actions to take by the near-real time RIC 232 and providing control signals to the one or more components of the system 201 that includes the DAS 200 to implement the determined actions. It should be understood that the adjustment of operation for one or more components of the DAS 200 can affect downlink operation, uplink operation, or both downlink operation and uplink operation.

In some examples, the near-real time RIC 232 is configured to adjust operation of one or more components of the system 201 that includes the DAS 200 by activating or deactivating modulation schemes (for example, used between the O-DU 205 and the RUs 106). In some examples, the near-real time RIC 232 is configured to activate or deactivate modulation schemes for a select functional split or for specific donors. In some examples, the near-real time RIC 232 communicates with the O-DU 205 and the RUs 106 to implement the activation or deactivation of modulation schemes.

In some examples, the near-real time RIC 232 is configured to adjust operation of one or more components of the system 201 that includes the DAS 200 by adjusting a number of layers (for example, multiple-input multiple-output layers), flows, or streams supported by the DAS 200. In some examples, the near-real time RIC 232 communicates with the O-DU 205 to implement adjustment of the number of layers, flows, or streams supported by the DAS 200.

In some examples, the near-real time RIC 232 is configured to adjust operation of one or more components of the system 201 that includes the DAS 200 by adjusting the transmit power and/or buffer sizes for one or more components of the DAS 200. In some examples, the near-real time RIC 232 communicates with the master unit 130, ICN 112, and/or FHM/FHGW 203 directly to implement adjustment of the number of layers, flows, or streams supported by the DAS 200.

In some examples, the near-real time RIC 232 is configured to adjust operation of one or more components of the system 201 that includes the DAS 200 by enabling or disabling functionality performed by one or more components of the DAS 200. For example, the near-real time RIC 232 can enable or disable functionality including, but not limited to, concatenation and IQ compression. In some examples, the near-real time RIC 232 communicates with the master unit 130, ICN 112, and/or FHM/FHGW 203 directly to implement enabling or disabling functionality.

In some examples, the near-real time RIC 232 is configured to adjust operation of one or more components of the system 201 that includes the DAS 200 by modifying the dimensioning of the transport network. For example, the near-real time RIC 232 can adjust the throughput capacities, ports, speed of the ports, Differentiated Services Code Point (DSCP) marking, virtual local area network (VLAN) tagging, or the like. In some examples, the near-real time RIC 232 communicates with the master unit 130, ICN 112, FHM/FHGW 203, and/or switches 202, 204 to implement dimensioning of the transport network.

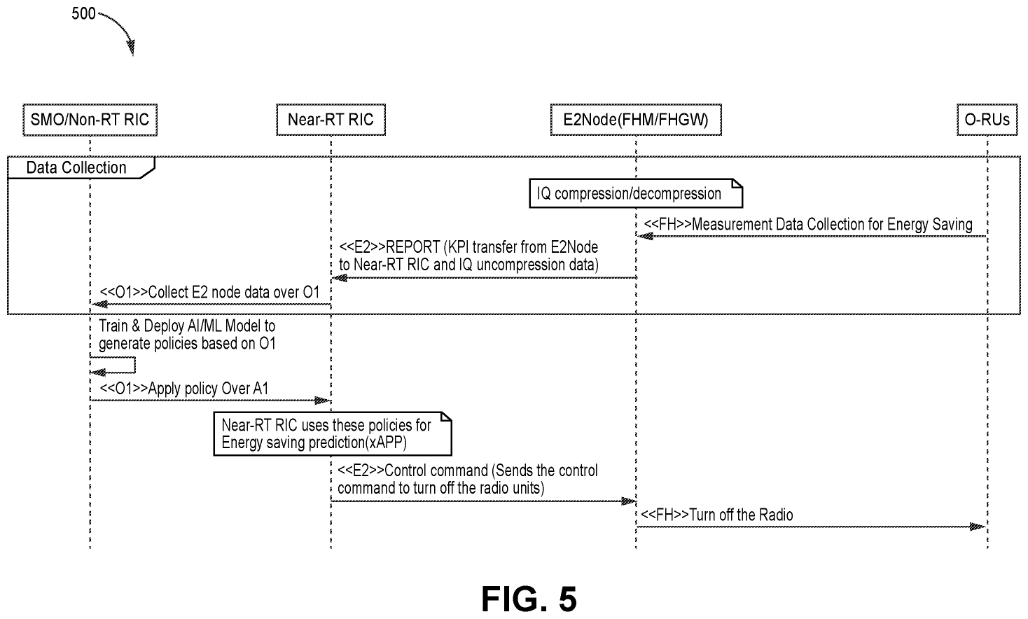

In some examples, the near-real time RIC 232 is configured to adjust operation of one or more components of the system 201 that includes the DAS 200 by adjusting the power consumption of the DAS 200. In some such examples, the near-real time RIC 232 can activate/deactivate streams and/or nodes of the DAS 200 depending on activity level indicated by the fronthaul information. For example, if one or more RUs are not being utilized (for example, the one or more RUs are not being combined in the uplink), then the streams to/from the one or more RUs and/or the RUs themselves can be disabled or deactivated. A particular example of energy savings for the DAS 200 is discussed further below with respect to FIG. 5.

In some examples, the near-real time RIC 232 is configured to adjust operation of one or more components of the system 201 that includes the DAS 200 by adjusting the overall latency of the DAS 200 to/from each RU 106. In some examples, the near-real time RIC 232 communicates with the master unit 130, ICN 112, and/or switches 202, 204 to implement adjustment of the overall latency of the DAS 200.

In some examples, the near-real time RIC 232 provides control signals to the one or more components of the system 201 that includes the DAS 200 to adjust operation of the one or more components of the DAS 200. For example, the near-real time RIC 232 can provide the control signals to the one or more components of the system 201 that includes the DAS 200 via an E2 interface. In some examples, the near-real time RIC 232 only transmits control signals to the master unit 130, ICNs 112, and FHM/FHGW 203 when a change is needed. In some examples, the near-real time RIC 232 transmits the control signals only to the components of the DAS 200 that require changes for the particular time period. In other examples, the near-real time RIC 232 broadcasts the updates to all of the components in the DAS 200, but only those components requiring change process the updates.

In one specific example for the ICN 112, the ICN 112 is configured to provide fronthaul information for all of the signals it is receiving in the uplink to the near-real time RIC 232 via the E2 interface. In some examples, the ICN 112 is configured to provide power levels for all of the signals it is receiving in the uplink to the near-real time RIC 232 in order to enable the near-real time RIC 232 to provide feedback or control signals related to uplink summing or combining by the ICN 112. In some such examples, the near-real time RIC 232 receives the fronthaul information from the ICN 112 (for example, the power levels) and provides control signals to configure the ICN 112 to perform summing and combining. In some examples, the near-real time RIC 232 provides control signals that specifically enable the ICN 112 to utilize noise rejection techniques during summing or combining.

FIG. 2B illustrates another exemplary embodiment of a DAS 200. The DAS 200 shown in FIG. 2B is the same as the DAS 200 shown in FIG. 2A except as described below. It should be noted that some of the components and interfaces between components (for example, the O1 interfaces) are omitted from FIG. 2B for clarity.

In the exemplary embodiment shown in FIG. 2B, the system 201 that includes the DAS 200 includes a first O-DU 210 that is coupled to, and configured to serve, the FHM/FHGW 211 and the DAS 200. In the example shown in FIG. 2B, the first O-DU 210 includes connections to the O-CU-CP 207 and O-CU-UP 209. In the example shown in FIG. 2B, the FHM/FHGW 211 is configured to comply with the O-RAN definition of an E2 node. In some examples, the FHM/FHGW 211 includes an E2 interface configured to communicate with the near-real time RIC 232 that is similar to the E2 interface as defined for the O-CU or O-DU in the O-RAN E2AP Specification. In some examples, the E2 interface of the FHM/FHGW 211 is dynamically enabled depending on whether a DAS is communicatively coupled to the FHM/FHGW 211. If there is no DAS communicatively coupled to the FHM/FHGW 211, then the E2 interface of the FHM/FHGW 211 is disabled. However, if there is a DAS communicatively coupled to the FHM/FHGW 211, then the E2 interface of the FHM/FHGW 211 is enabled.

In the exemplary embodiment shown in FIG. 2B, the system 201 that includes the DAS 200 includes a second O-DU 212 that is coupled to, and configured to serve, the FHM/FHGW 213 and a 3GPP 5G NR network that does not include a DAS. In the example shown in FIG. 2B, the second O-DU 212 includes connections to the O-CU-CP 207 and O-CU-UP 209. In the example shown in FIG. 2B, the FHM/FHGW 213 is configured to comply with the O-RAN definition of an E2 node. In some examples, the FHM/FHGW 213 includes an E2 interface configured to communicate with the near-real time RIC 232 that is similar to the E2 interface as defined for the O-CU or O-DU in the O-RAN E2AP Specification.

During operation, the FHM/FHGW 211 and FHM/FHGW 213 are both configured to provide fronthaul information (for example, using a REPORT message as defined in the O-RAN E2AP Specification) to the near-real time RIC 232 via the E2 interface in a manner similar to that described above with respect to FIG. 2A. The near-real time RIC 232 is configured to process the fronthaul information from the FHM/FHGW 211 and adjust operation of one or more components of the system 201 that includes the DAS 200 (for example, the master unit 130, ICN 112, switches 202, 204, and/or FHM/FHGW 211) based on the one or more automatically generated operational parameters for the DAS nodes. The near-real time RIC 232 is also configured to process the fronthaul information from the FHM/FHGW 213 and automatically generate one or operational parameters for the nodes of the 3GPP 5G NR network and adjust operation of one or more components of the system 201 for the 3GPP 5G NR network (for example, the O-DU 212, FHM/FHGW 213, and/or O-RU 206) based on the one or more automatically generated operational parameters.

FIG. 2C illustrates another exemplary embodiment of a DAS 200. The DAS 200 shown in FIG. 2C is the same as the DAS 200 shown in FIG. 2A except as described below. It should be noted that some of the components and interfaces between components (for example, the O1 interfaces) are omitted from FIG. 2C for clarity.

In the exemplary embodiment shown in FIG. 2C, the master unit 130 and the FHM/FHGW 215 are collocated, and the FHM/FHGW 215 is deployed specifically for the DAS 200. In some examples, the master unit 130 and the FHM/FHGW 215 are containerized or virtualized functions or applications that can run on COTS hardware. In some examples, the master unit 130 and FHM/FHGW 215 functions can be running on the same bare metal hardware (server) and orchestrated by the non-real time RIC 234 to be on the same server via the O1 interface.

It should be understood that the number of O-DUs and FHM/FHGWs, and the relationships between them, are not limited to the examples shown in FIGS. 2A-2C. An O-DU can serve a single FHM/FHGW or multiple FHM/FHGW, and a single FHM/FHGW can be communicatively coupled to one or more O-DUs depending on the number of operators.

FIG. 2D illustrates another exemplary embodiment of a DAS 200. The DAS 200 shown in FIG. 2D is the same as the DAS 200 shown in FIG. 2C except as described below. It should be noted that some of the components and interfaces between components (for example, the O1 interfaces) are omitted from FIG. 2D for clarity.

In the exemplary embodiment shown in FIG. 2D, the master unit 130 is communicatively coupled to the O-DU 216 without use of an FHM/FHGW. During operation, the master unit 130 and the ICN 112 are both configured to provide fronthaul information (for example, using a REPORT message as defined in the O-RAN E2AP Specification) to the near-real time RIC 232 via the E2 interface in a manner similar to that described above. The near-real time RIC 232 is configured to process the fronthaul information from the components of the DAS 200 and adjust operation of one or more components of the system 201 that includes the DAS 200 (for example, the O-DU 216, master unit 130, ICN 112, and/or switches 202, 204) based on the one or more automatically generated operational parameters for the DAS nodes.

Other configurations and examples can be implemented in other ways.

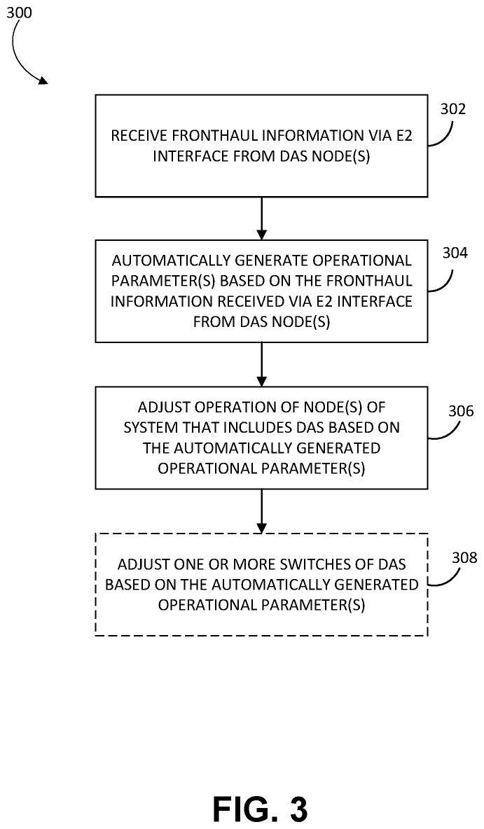

FIG. 3 illustrates a flow diagram of an example method 300 for using a radio intelligent controller with a DAS. The common features discussed above with respect to the base stations in FIGS. 1A-2D can include similar characteristics to those discussed with respect to method 300 and vice versa.

The blocks of the flow diagram in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel in an event-driven manner). In some examples, method 300 is performed by a radio intelligent controller (for example, a near-real time RIC).

The method 300 includes receiving fronthaul information via an E2 interface from one or more nodes of a DAS (block 302). In some examples, the nodes of the DAS that provide fronthaul information include one or more FHM/FHGWs, one or more master units, one or more ICNs, and/or one or more RUs. The fronthaul information can include, but is not limited to, an indication regarding whether IQ data packets are compressed or uncompressed, information from eCPRI headers (for example, stream information, channel information, etc.), eCPRI control/signal message packets (for example, delay or latency measurements, buffer status, transmit power via Real Time Control Data (RTCD)), transport network performance measure (jitter, block error rate (BER), etc.), a number of RUs connected in the downlink, a number of RUs connected in the uplink (for example, for the UE based on the noise floor set), link capacity (for example, including total capacity and the headroom for inbound and outbound at the node), topology information for the cell (for example, hierarchy information, location information, etc.).

The method 300 further includes automatically generating one or more operational parameters based on the fronthaul information received via an E2 interface from one or more nodes of the DAS (block 304). In some examples, the one or more automatically generated operational parameters are generated using the at least some of the fronthaul information and one or more machine learning models of the near-real time RIC. In some examples, the one or more automatically generated operational parameters include one or more predicted operational parameters. The one or more automatically generated operational parameters can be for a node of the DAS (for example, FHM/FHGW, master unit, ICN, or RU) or for a node of the system that is not a node of the DAS (for example, O-DU).

The method 300 further includes adjusting one or more components of the system that includes the DAS based on the one or more automatically generated operational parameters (block 306). In some examples, adjusting one or more components of the system that includes the DAS includes determining actions to take based on the one or more automatically generated operational parameters and providing control signals to the one or more nodes of the DAS to implement the actions (changes). The adjustment can include adjusting one or more parameters of operation for a node of the DAS (for example, FHM/FHGW, master unit, ICN, or RU) or for a node of the system that is not a node of the DAS (for example, O-DU).

The method 300 optionally includes adjusting one or more switches of the DAS based on the one or more automatically generated operational parameters (block 308). In some examples, adjusting one or more switches of the DAS includes determining actions to take based on the one or more automatically generated operational parameters and providing control signals to a controller for the switches of the DAS to implement the actions (changes). In some such examples, the controller for the switches of the DAS includes an SDN controller and the SDN controller can be configured to provide the updates to the forwarding rules for the aggregation switch and/or the access switch via the out-of-band control messaging.

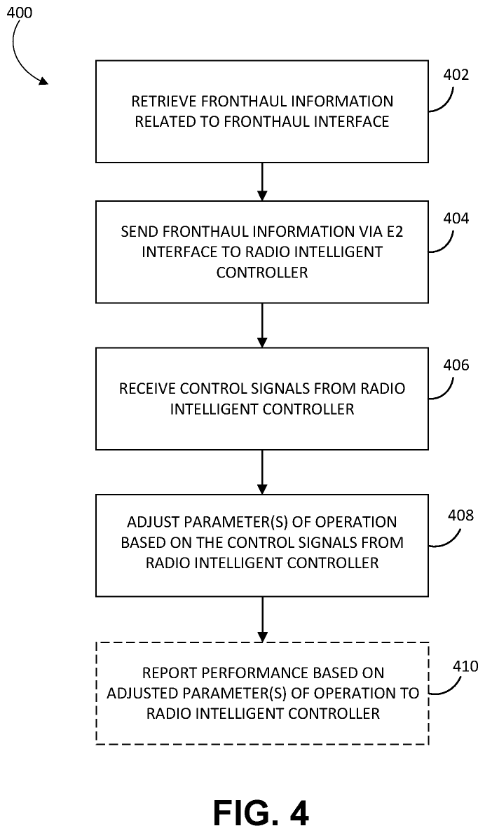

FIG. 4 illustrates a flow diagram of an example method 400 for using a radio intelligent controller with a DAS. The common features discussed above with respect to the base stations in FIGS. 1A-2D can include similar characteristics to those discussed with respect to method 300 and vice versa.

The blocks of the flow diagram in FIG. 4 have been arranged in a generally sequential manner for ease of explanation; however, it is to be understood that this arrangement is merely exemplary, and it should be recognized that the processing associated with method 400 (and the blocks shown in FIG. 4) can occur in a different order (for example, where at least some of the processing associated with the blocks is performed in parallel in an event-driven manner). In some examples, method 400 is performed by a node of a DAS (for example, the FHM/FHGW, master unit, ICN, RU, or switch).

The method 400 includes retrieving fronthaul information related to the fronthaul interface (block 402). In some examples, the node of the DAS is configured to retrieve the fronthaul information periodically or based on an event (for example, a request from the near-real time RIC or trigger condition). The fronthaul information can include, but is not limited to, an indication regarding whether IQ data packets are compressed or uncompressed, information from eCPRI headers (for example, stream information, channel information, etc.), eCPRI control/signal message packets (for example, delay or latency measurements, buffer status, transmit power via Real Time Control Data (RTCD)), transport network performance measure (jitter, block error rate (BER), etc.), a number of RUs connected in the downlink, a number of RUs connected in the uplink (for example, for the UE based on the noise floor set), link capacity (for example, including total capacity and the headroom for inbound and outbound at the node), topology information for the cell (for example, hierarchy information, location information, etc.). It should be understood that any fronthaul information that can be obtained without deep packet inspection at the eCPRI level can be retrieved by the node of the DAS.

The method 400 further includes sending the fronthaul information via an E2 interface to the radio intelligent controller (block 404). In some examples, the fronthaul information is provided via a REPORT message as defined in the O-RAN E2AP Specification.

The method 400 further includes receiving control signals from the radio intelligent controller (block 406). In some examples, the control signals are received via a COMMAND message as defined in the O-RAN E2AP Specification. In some examples, the node of the DAS is configured to receive the control signals from the radio intelligent controller indirectly (for example, RU can receive control signals via another component of the DAS or switch can receive control signals via a controller).

The method 400 further includes adjusting one or more parameters of operation based on the control signals from the radio intelligent controller (block 408). In some examples, the node of the DAS updates one or more of its operational parameters as instructed in the control signals from the radio intelligent controller.

In some examples, the method 400 optionally includes reporting performance based on the adjusted one or more parameters of operation to the radio intelligent controller (block 410). In some examples, the reporting is performed periodically or after receiving a request from the radio intelligent controller. In some examples, the reporting creates a feedback loop for the radio intelligent controller to better optimize performance of the DAS and the system that includes the DAS.

FIG. 5 illustrates an energy savings operation 500 for a DAS. The common features discussed above with respect to the base stations in FIGS. 1A-4 can include similar characteristics to those discussed with respect to energy savings operation 500 and vice versa.

As shown in FIG. 5, the energy savings operation 500 starts with the O-RUs collecting measurement data for energy savings and providing the collected measurement data to an E2 node over the fronthaul network. In the example shown in FIG. 5, the E2 node is an FHM/FHGW.

Upon receipt of the collected measurement data, the E2 node is configured to decompress the IQ data, if applicable, and send a REPORT message over the E2 interface to the near-real time RIC. In some examples, the REPORT message includes key performance indicators (KPIs) for the DAS.

Upon receipt of the collected E2 node data, the near-real time RIC is configured to provide the collected E2 node data to the SMO or non-real time RIC via the O1 interface. In some examples, the SMO or non-real time RIC is configured to store the collected E2 node data in a data repository for future use (for example, for policy development and/or training for machine learning models).

Using the collected E2 node data, the SMO or non-real time RIC is configured to train AI/ML model(s) and generate policies. The SMO or non-real time RIC is configured to deploy the AI/ML model(s) and provide the policy guidance to the near-real time RIC over the A1 interface.

The near-real time RIC uses the deployed AI/ML model(s) and policies for energy savings predictions. In some examples, the deployed AI/ML model(s) and policies for energy savings predictions are utilized in one or more xApps at the near-real time RIC.

Based on the energy savings predictions, the near-real time RIC generates and sends CONTROL command messages to the E2 node via the E2 interface. In some examples, the control signals include instructions to turn off the O-RUs (for example, due to lack of use).

The E2 node is configured to implement the CONTROL command messages by providing instruction to the O-RU to deactivate over the fronthaul network (for example, using a management plane).

By using the techniques described herein, a system that includes a DAS and/or FHM/FHGW can satisfy the requirements of being an O-RAN compliant network and utilize radio intelligent controller(s) (near-real time RIC and/or non-real time RIC) to optimize the deployment for higher performance, better capacity, etc. When the radio intelligent controller(s) are connected to the nodes of the DAS and/or FHM/FHGW in combination with the baseband unit entities (for example, O-CU and O-DU), the optimization by the radio intelligent controller(s) can occur end-to-end and provide further improvements to coverage, capacity, and performance.

### Example Embodiments

Example 1 includes a method for using a radio intelligent controller with a distributed antenna system (DAS), comprising: receiving fronthaul information via an E2 interface from one or more nodes of the DAS included in a system; automatically generating one or more operational parameters for one or more components of the system that includes the DAS based on the fronthaul information received via an E2 interface from the one or more nodes of the DAS; and adjusting operation of one or more components of the system that includes the DAS based on the one or more automatically generated operational parameters for the one or more components of the system that includes the DAS.

Example 2 includes the method of Example 1, wherein automatically generating one or more automatically generated operational parameters for the one or more components of the system that includes the DAS includes automatically generating one or more predicted operational parameters for the one or more components of the system that includes the DAS using one or more machine learning models.

Example 3 includes the method of any of Examples 1-2, wherein the one or more nodes of the DAS include a fronthaul multiplexer/fronthaul gateway (FHM/FHGW), a master unit, and/or an intermediary combining node (ICN).

Example 4 includes the method of any of Examples 1-3, wherein the one or more nodes of the DAS include a fronthaul multiplexer/fronthaul gateway (FHM/FHGW) and a master unit, the method further comprising dynamically enabling an E2 interface of the FHM/FHGW in response to the FHM/FHGW being communicatively coupled to the master unit.

Example 5 includes the method of any of Examples 1-4, wherein the one or more nodes of the DAS include an intermediary combining node (ICN), the method comprising: receiving, via an E2 interface from the ICN, power level information for uplink signals received by the ICN; automatically generating one or more operational parameters for the ICN based on the power level information for uplink signals received via the E2 interface from the ICN; and adjusting a summing or combining operation of the ICN based on the one or more automatically generated operational parameters for the ICN.

Example 6 includes the method of any of Examples 1-5, wherein the one or more nodes of the DAS includes a master unit communicatively coupled to and located remotely from a plurality of radio units, wherein the master unit is communicatively coupled to the plurality of radio units via one or more switches.

Example 7 includes the method of Example 6, wherein adjusting operation of one or more components of the system that includes the DAS based on the one or more automatically generated operational parameters for the one or more components of the system that includes the DAS includes: determining one or more modifications for the master unit, the one or more switches, and/or the plurality of radio units based on the one or more automatically generated operational parameters; and providing control signals to the master unit, the one or more switches, and/or the plurality of radio units to implement the one or more modifications.

Example 8 includes the method of Example 7, wherein providing control signals to the master unit, the one or more switches, and/or the plurality of radio units to implement the one or more modifications includes providing control signals to the one or more switches via a controller communicatively coupled to the one or more switches, wherein the controller is configured to communicate with the radio intelligent controller via an E2 interface.

Example 9 includes the method of any of Examples 1-8, wherein adjusting operation of one or more components of the system that includes the DAS based on the one or more automatically generated operational parameters for the one or more components of the system that includes the DAS includes: activating or deactivating modulation schemes used by the system; reducing a number of layers, flows, or streams supported by the DAS; adjusting a transmit power and/or buffer size for one or more nodes of the DAS; enabling or disabling functionality performed by one or more components of the DAS; modifying dimensioning of a transport network of the system; adjusting power consumption of the DAS; and/or adjusting overall latency of the DAS to/from each radio unit of the DAS.

Example 10 includes a system, comprising: a master unit communicatively coupled to one or more baseband unit entities; a plurality of radio units communicatively coupled to the master unit, wherein the plurality of radio units is located remotely from the master unit; and a radio intelligent controller communicatively coupled to the master unit, wherein the radio intelligent controller is configured to: receive fronthaul information via an E2 interface from the master unit; automatically generate one or more operational parameters for one or more components of the system based on the fronthaul information received via an E2 interface from the master unit; and adjust operation of one or more components of the system based on the one or more automatically generated operational parameters.

Example 11 includes the system of Example 10, further comprising a fronthaul multiplexer/fronthaul gateway (FHM/FHGW), wherein the master unit is communicatively coupled to the one or more baseband unit entities via the FHM/FHGW, wherein the radio intelligent controller is communicatively coupled to the FHM/FHGW and further configured to: receive fronthaul information via an E2 interface from the FHM/FHGW; and automatically generate the one or more operational parameters for one or more components of the system based on the fronthaul information received via an E2 interface from the master unit and the FHM/FHGW.

Example 12 includes the system of Example 11, wherein the FHM/FHGW is configured to serve the master unit and at least one radio unit that is not communicatively coupled to the master unit.

Example 13 includes the system of any of Examples 11-12, wherein the FHM/FHGW is configured to enable an E2 interface for communication with the radio intelligent controller in response to being communicatively coupled to the master unit.

Example 14 includes the system of Example 13, wherein the FHM/FHGW is configured to serve the master unit; the system further comprising a second FHM/FHGW configured to serve at least one radio unit that is not communicatively coupled to the master unit, wherein the second FHM/FHGW is configured to deactivate an E2 interface for communication with the radio intelligent controller in response to being communicatively coupled to the at least one radio unit that is not communicatively coupled to the master unit

Example 15 includes the system of any of Examples 10-14, wherein the system further comprises one or more intermediary combining nodes (ICNs) communicatively coupled between the master unit and the plurality of radio units, wherein the one or more ICNs are configured to provide power level information for uplink signals to the radio intelligent controller via an E2 interface; wherein the radio intelligent controller is configured to: automatically generate one or more operational parameters for the one or more ICNs based on the power level information for uplink signals received via the E2 interface from the ICNs; and adjust a summing or combining operation of the one or more ICNs based on the one or more automatically generated operational parameters for the ICN.

Example 16 includes the system of any of Examples 10-15, wherein the master unit is communicatively coupled to the plurality of radio units via one or more switches.

Example 16 includes the system of Example 16, wherein the radio intelligent controller is configured to provide control signals to the one or more switches via a controller communicatively coupled to the one or more switches, wherein the controller is configured to communicate with the radio intelligent controller via an E2 interface.

Example 18 includes the system of any of Examples 16-17, wherein the radio intelligent controller is configured to adjust operation of one or more components of the system by: determining one or more modifications for the master unit, the one or more switches, and/or the plurality of radio units based on the one or more operational parameters; and providing control signals to the master unit, the one or more switches, and/or the plurality of radio units to implement the one or more modifications.

Example 19 includes the system of any of Examples 10-18, wherein the one or more components of the system are configured to adjust operation of one or more components of the system by: activating or deactivating modulation schemes used by the system; reducing a number of layers, flows, or streams supported by the system; adjusting a transmit power and/or buffer size for one or more nodes of the system; enabling or disabling functionality performed by one or more components of the system; modifying dimensioning of a transport network of the system; adjusting power consumption of the system; and/or adjusting overall latency of the system to/from each radio unit of the plurality of radio units.

Example 20 includes a system, comprising: a fronthaul multiplexer/fronthaul gateway (FHM/FHGW) communicatively coupled to one or more baseband unit entities; one or more radio units communicatively coupled to the FHM/FHGW, wherein the one or more radio units are located remotely from the FHM/FHGW; and a radio intelligent controller communicatively coupled to the FHM/FHGW, wherein the radio intelligent controller is configured to: receive fronthaul information via an E2 interface from the FHM/FHGW; automatically generate one or more operational parameters for one or more components of the system based on the fronthaul information received via an E2 interface from the FHM/FHGW; and adjust operation of one or more components of the system based on the one or more automatically generated operational parameters.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A method for using a radio intelligent controller with a distributed antenna system (DAS), comprising:
receiving fronthaul information via an E2 interface from one or more nodes of the DAS included in a system;
automatically generating one or more operational parameters for one or more components of the system that includes the DAS based on the fronthaul information received via an E2 interface from the one or more nodes of the DAS; and
adjusting operation of one or more components of the system that includes the DAS based on the one or more automatically generated operational parameters for the one or more components of the system that includes the DAS.

2. The method of claim 1, wherein automatically generating one or more automatically generated operational parameters for the one or more components of the system that includes the DAS includes automatically generating one or more predicted operational parameters for the one or more components of the system that includes the DAS using one or more machine learning models.

3. The method of claim 1, wherein the one or more nodes of the DAS include a fronthaul multiplexer/fronthaul gateway (FHM/FHGW), a master unit, and/or an intermediary combining node (ICN).

4. The method of claim 1, wherein the one or more nodes of the DAS include a fronthaul multiplexer/fronthaul gateway (FHM/FHGW) and a master unit, the method further comprising dynamically enabling an E2 interface of the FHM/FHGW in response to the FHM/FHGW being communicatively coupled to the master unit.

5. The method of claim 1, wherein the one or more nodes of the DAS include an intermediary combining node (ICN), the method comprising:
receiving, via an E2 interface from the ICN, power level information for uplink signals received by the ICN;
automatically generating one or more operational parameters for the ICN based on the power level information for uplink signals received via the E2 interface from the ICN; and
adjusting a summing or combining operation of the ICN based on the one or more automatically generated operational parameters for the ICN.

6. The method of claim 1, wherein the one or more nodes of the DAS includes a master unit communicatively coupled to and located remotely from a plurality of radio units, wherein the master unit is communicatively coupled to the plurality of radio units via one or more switches.

7. The method of claim 6, wherein adjusting operation of one or more components of the system that includes the DAS based on the one or more automatically generated operational parameters for the one or more components of the system that includes the DAS includes:
determining one or more modifications for the master unit, the one or more switches, and/or the plurality of radio units based on the one or more automatically generated operational parameters; and
providing control signals to the master unit, the one or more switches, and/or the plurality of radio units to implement the one or more modifications.

8. The method of claim 7, wherein providing control signals to the master unit, the one or more switches, and/or the plurality of radio units to implement the one or more modifications includes providing control signals to the one or more switches via a controller communicatively coupled to the one or more switches, wherein the controller is configured to communicate with the radio intelligent controller via an E2 interface.

9. The method of claim 1, wherein adjusting operation of one or more components of the system that includes the DAS based on the one or more automatically generated operational parameters for the one or more components of the system that includes the DAS includes:
activating or deactivating modulation schemes used by the system;
reducing a number of layers, flows, or streams supported by the DAS;
adjusting a transmit power and/or buffer size for one or more nodes of the DAS;
enabling or disabling functionality performed by one or more components of the DAS;
modifying dimensioning of a transport network of the system;
adjusting power consumption of the DAS; and/or
adjusting overall latency of the DAS to/from each radio unit of the DAS.

10. A system, comprising:
a master unit communicatively coupled to one or more baseband unit entities;
a plurality of radio units communicatively coupled to the master unit, wherein the plurality of radio units is located remotely from the master unit; and
a radio intelligent controller communicatively coupled to the master unit, wherein the radio intelligent controller is configured to:
receive fronthaul information via an E2 interface from the master unit;
automatically generate one or more operational parameters for one or more components of the system based on the fronthaul information received via an E2 interface from the master unit; and
adjust operation of one or more components of the system based on the one or more automatically generated operational parameters.

11. The system of claim 10, further comprising a fronthaul multiplexer/fronthaul gateway (FHM/FHGW), wherein the master unit is communicatively coupled to the one or more baseband unit entities via the FHM/FHGW, wherein the radio intelligent controller is communicatively coupled to the FHM/FHGW and further configured to:
receive fronthaul information via an E2 interface from the FHM/FHGW; and
automatically generate the one or more operational parameters for one or more components of the system based on the fronthaul information received via an E2 interface from the master unit and the FHM/FHGW.

12. The system of claim 11, wherein the FHM/FHGW is configured to serve the master unit and at least one radio unit that is not communicatively coupled to the master unit.

13. The system of claim 11, wherein the FHM/FHGW is configured to enable an E2 interface for communication with the radio intelligent controller in response to being communicatively coupled to the master unit.

14. The system of claim 13, wherein the FHM/FHGW is configured to serve the master unit;
the system further comprising a second FHM/FHGW configured to serve at least one radio unit that is not communicatively coupled to the master unit, wherein the second FHM/FHGW is configured to deactivate an E2 interface for communication with the radio intelligent controller in response to being communicatively coupled to the at least one radio unit that is not communicatively coupled to the master unit.

15. The system of claim 10, wherein the system further comprises one or more intermediary combining nodes (ICNs) communicatively coupled between the master unit and the plurality of radio units, wherein the one or more ICNs are configured to provide power level information for uplink signals to the radio intelligent controller via an E2 interface;
wherein the radio intelligent controller is configured to:
automatically generate one or more operational parameters for the one or more ICNs based on the power level information for uplink signals received via the E2 interface from the ICNs; and
adjust a summing or combining operation of the one or more ICNs based on the one or more automatically generated operational parameters for the ICN.

16. The system of claim 10, wherein the master unit is communicatively coupled to the plurality of radio units via one or more switches.

17. The system of claim 16, wherein the radio intelligent controller is configured to provide control signals to the one or more switches via a controller communicatively coupled to the one or more switches, wherein the controller is configured to communicate with the radio intelligent controller via an E2 interface.

18. The system of claim 16, wherein the radio intelligent controller is configured to adjust operation of one or more components of the system by:
determining one or more modifications for the master unit, the one or more switches, and/or the plurality of radio units based on the one or more operational parameters; and
providing control signals to the master unit, the one or more switches, and/or the plurality of radio units to implement the one or more modifications.

19. The system of claim 10, wherein the one or more components of the system are configured to adjust operation of one or more components of the system by:
activating or deactivating modulation schemes used by the system;
reducing a number of layers, flows, or streams supported by the system;
adjusting a transmit power and/or buffer size for one or more nodes of the system;
enabling or disabling functionality performed by one or more components of the system;
modifying dimensioning of a transport network of the system;
adjusting power consumption of the system; and/or
adjusting overall latency of the system to/from each radio unit of the plurality of radio units.

20. A system, comprising:
a fronthaul multiplexer/fronthaul gateway (FHM/FHGW) communicatively coupled to one or more baseband unit entities;
one or more radio units communicatively coupled to the FHM/FHGW, wherein the one or more radio units are located remotely from the FHM/FHGW; and
a radio intelligent controller communicatively coupled to the FHM/FHGW, wherein the radio intelligent controller is configured to:
receive fronthaul information via an E2 interface from the FHM/FHGW;
automatically generate one or more operational parameters for one or more components of the system based on the fronthaul information received via an E2 interface from the FHM/FHGW; and
adjust operation of one or more components of the system based on the one or more automatically generated operational parameters.
